(19) United States
(12) Patent Application Publication
(10) Pub. No.: US 2003/0134750 A1
(43) Pub. Date: Jul. 17, 2003

(54) Multiplex winding helical structure and fuctional material

(76) Inventor: Ryuichi Ugajin, Tokyo (JP)

Correspondence Address: SONNENSCHEIN NATH & ROSENTHAL, P.O. BOX 061080, WACKER DRIVE STATION, CHICAGO, IL, 60606-1080, US

(21) Appl. No.: 10/182,486

(22) PCT Filed: Nov. 28, 2001
(86) PCT No.: PCT/JP01/10375

(30) Foreign Application Priority Data
Nov. 30, 2000 (JP) 2000366054

(51) Int. Cl. H01B 1/00; H01F 1/00; C04B 2/00; C10F 5/00

(52) U.S. Cl. 505/100

(57) ABSTRACT

In a multiply-twisted helix including having a hierarchical structure in which a linear structure as an element of a particular spiral structure is made of a thinner spiral structure, the spiral structures being bonded in at least one site at least between two layers, and the number of turns of the spiral structure of the lowest layer being N, the interval of bonds between m-th degree layers in the multiply-twisted helix is determined by the power function N^{g(m)} of N having an arbitrary linear function g(m)=βm+γ (where β and γ are constant values and γ≠0) of m as its exponent.

### TECHNICAL FIELD

This invention relates to a multiply-twisted helix and a functional material, especially suitable for use as highly functional materials based on a novel principle.

### BACKGROUND ART

For application of a solid material to electronic or optical devices, physical properties of the material may restrict its applications. For example, in case of using a semiconductor material in a light-emitting device, it will be usable in a device of an emission wavelength corresponding to the band gap of the material, but some consideration will be necessary for changing the emission wavelength. Regarding physical properties related to semiconductor bands, controls by superlattices have been realized. More specifically, by changing the period of a superlattice, the bandwidth of its subband can be controlled to design an emission wavelength.

Targeting on controlling many-electron-state structures by material designs, the Inventor proposed many-body effect engineering by quantum dot-based structures and has continued theoretical analyses ((1) U.S. Pat. No. 5,430,309; (2) U.S. Pat. No. 5,663,571; (3) U.S. Pat. No. 5,719,407; (4) U.S. Pat. No. 5,828,090; (5) U.S. Pat. No. 5,831,294; (6) J. Appl. Phys. 76, 2833(1994); (7) Phys. Rev. B51, 10714(1995); (8) Phys. Rev. B51, 11136(1995); (9) J. Appl. Phys. 77, 5509(1995); (10) Phys. Rev. B53, 6963(1996); (11) Phys. Rev. B53, 10141(1996); (12) Appl. Phys. Lett. 68, 2657(1996); (13) J. Appl. Phys. 80, 3893(1996); (14) J. Phys. Soc. Jpn. 65, 3952(1996); (15) Jpn. J. Appl. Phys. 36, 638(1997); (16) J. Phys. Soc. Jpn. 66, 425(1997); (17) J. Appl. Phys. 81, 2693 (1997); (18) Physica (Amsterdam) 229B, 146(1997); (19) Physica (Amsterdam) 237A, 220(1997); (20) Surf. Sci. 375, 403(1997); (21) Physica (Amsterdam) 240B, 116(1997); (22) Physica (Amsterdam) 240B, 128(1997); (23) Physica (Amsterdam) IE, 226(1997); (24) Phys. Rev. Lett. 80, 572(1998); (25) Jpn. J. Appl. Phys. 37, 863(1998); (26) Physica (Amsterdam) 245B, 311(1998); (27) Physica (Amsterdam) 235B, 96(1998); (28) Phys. Rev. B59, 4952(1999); (29) Surf. Sci. 432, 1(1999); (30) International Journal of Modern Physics B. Vol. 13, No. 21, 22, pp. 2689-2703, 1999). For example, realization of various correlated electronic systems is expected by adjusting a tunneling phenomenon between quantum dots and interaction between electrons in quantum dots. Let the tunneling transfer between adjacent quantum dots be written as t. Then, if quantum dots are aligned in form of a tetragonal lattice, the bandwidth of one electron state is T_{eff}=4t. If quantum dots form a one-dimensional chain, the bandwidth of one electron state is T_{eff}=2t. In case of a three-dimensional quantum dot array, T_{eff}=6t. That is, if D is the dimensionality of a quantum dot array, the bandwidth of one electron state is T_{eff}=2Dt. Here is made a review about half-filled (one electron per each quantum dot) Mott transition (also called Mott-Hubbard transition or Mott metal-insulator transition). Let the effective interaction of electrons within a quantum dot be written as U_{eff}, then the Hubbard gap on the part of the Mott insulator is substantially described as Δ=U_{eff}−T_{eff}. It means that the Mott transition can be controlled by changing U_{eff} of t. As already proposed, the Mott-Hubbard transition can be controlled by adjusting U_{eff} or t, using a field effect, and it is applicable to field effect devices (Literatures (5), (6), (11) and (14) introduced above).

On the other hand, reviewing the equation Δ=U_{eff}−T_{eff}=U_{eff}−2Dt, it will be possible to control Mott-Hubbard transition as well by controlling the dimensionality D of the system. For this purpose, the Applicant already proposed a fractal-based structure that can continuously change the dimensionality, and have heretofore demonstrated that Mott-Hubbard transition is controllable by changing the fractal dimensions.

To enable designing of wider materials, it is desired to modify and control the dimension of materials by methods different from the fractal theory. For example, for the purpose of changing the nature of phase transition, it is the first-coming idea to control the number of nearest-neighbor elements among elements forming a material.

It is therefore an object of the invention to provide a multiply-twisted helix complementary with a fractal-shaped material and exhibiting a new physical property, and a functional material using the multiply-twisted helix.

### DISCLOSURE OF INVENTION

The Inventor proposes a multiply-twisted helix as one of spatial filler structures. This is made by coiling a spiral based on a spiral structure like a chromatin structure that a gene represents, and by repeating it to progressively fill a three-dimensional space. By adjusting the spiral pitch, any spatial filling ratio can be selected, and dimensionality of a material, i.e. the number of nearest-neighbor elements in this structure, can be modified.

In other words, here is proposed a multiply-twisted helix in which a spiral is made of a spiral structure as the basic element. In this structure including hierarchical multiple spirals, one-dimensional vacancies penetrate the structure to form a structure similar to that of a porous material. However, by adjusting the turn pitch of the spirals, the number of nearest-neighbor elements can be changed. According to researches by the Inventor, the value of critical electron interaction of Mott-Hubbard metal-insulator transition in this kind of structure can be controlled by the turn pitch.

The multiply-twisted helical structure may be formed regularly; however, in case a multiply-twisted helical structure is actually made, bonding positions appearing between every adjacent spiral layers possibly distribute randomly. The degree of the randomness can be new freedom of material designs. Taking it into consideration, for the purpose of clarifying effects of the random distribution, exact simulation was conducted. As a result, introduction of randomness has been proved to increase the width of the Mott-Hubbard gap and enhance the Mott insulation property. Therefore, the value of critical electron-electron interaction of Mott-Hubbard metal-insulator transition can be controlled not only by controlling the degree of randomness of the spiral turn pitch but also by controlling the degree of randomness regarding bonding positions between layers.

Still in the multiply-twisted helix, its control parameters include bonding positions between layers in addition to the degree of randomness regarding the spiral turn pitch and bonding positions between layers. That is, by controlling bonding positions between layers, desired material designs are possible. More specifically, freedom of parallel movements of bonding between layers, that is in other words, simultaneous parallel movements of bonding positions between layers, can be used to control the value of critical electron interaction of Mott-Hubbard metal-insulator transition appearing in the structure.

According to further researches and knowledge obtained thereby, although the interaction between layers takes place in intervals of N, N², N³, . . . in the above-explained multiply-twisted helix such that a spiral structure of a certain hierarchy level is made up of a spiral structure of the next lower hierarchy level, the spatial bonding property in the structure can be controlled by the degree of freedom N^{m-1} for the interval N^{m}.

As a result of still further researches, it has been found that the spatial bondability of a multiply-twisted helix, i.e. the global bondability between elements, can be controlled by changing the exponent of the bonding interval between layers. More specifically, it has been found that, when the interval N^{m} is generalized and an arbitrary one-dimensional function g(m)=βm+γ is assumed as the exponent of N, new design freedom can be introduced especially under γ≠0, and the width of the Hubbard gap in, for example, a half-filled Mott insulator, i.e. the intensity of electron correlation, can be controlled by means of that exponent.

The present invention has been made as a result of vigorous studies based on those researches by the Inventor.

That is, to overcome the above-indicated problems, according to the first aspect of the invention, there is provided a multiply-twisted helix having a hierarchical structure in which a linear structure as an element of a particular spiral structure is made of a thinner spiral structure, the spiral structures being bonded in at least one site at least between two layers, and the number of turns of the spiral structure of the lowest layer being N, characterized in:

the interval of m-th degree bonds between layers being determined by the power function N^{g(m)} of N having an arbitrary linear function g(m)=βm+γ (where β and γ are constant values and γ≠0) of m as its exponent.

According to the second aspect of the invention, there is provided a functional material at least partly made up of a multiply-twisted helix including having a hierarchical structure in which a linear structure as an element of a particular spiral structure is made of a thinner spiral structure, the spiral structures being bonded in at least one site at least between two layers, and the number of turns of the spiral structure of the lowest layer being N, characterized in:

the interval of m-th degree bonds between layers in the multiply-twisted helix being determined by the power function N^{g(m)} of N having an arbitrary linear function g(m)=βm+γ (where β and γ are constant values and γ≠0) of m as its exponent.

In the present invention, bondability between elements of the spiral structure is controlled, or the electron correlation in the electron system on the spiral structure is controlled by setting β or γ at predetermined values.

According to the invention having the above-summarized configuration, the spatial bondability in a multiply-twisted helix variable in exponent of bonding intervals between layers, that is, the global bondability between elements, can be controlled by changing the exponent, and physical property induced thereby can be controlled.

### BRIEF DESCRIPTION OF DRAWINGS

FIG. 1 is a schematic diagram that shows actual bonding in the first example of multiply-twisted helical structure proposed by the Inventor in case of N=4;

FIG. 2 is a schematic diagram that schematically shows the first example of multiply-twisted helix;

FIG. 3 is a schematic diagram that shows a density of states obtained by numerical calculation in case of N=2 in the first example of multiply-twisted helix;

FIG. 4 is a schematic diagram that shows a density of states obtained by numerical calculation in case of N=4 in the first example of multiply-twisted helix;

FIG. 5 is a schematic diagram that shows a density of states obtained by numerical calculation in case of N=6 in the first example of multiply-twisted helix;

FIG. 6 is a schematic diagram that shows a density of states obtained by numerical calculation in case of N=10 in the first example of multiply-twisted helix;

FIG. 7 is a schematic diagram that shows a density of states obtained by numerical calculation in case of N=20 in the first example of multiply-twisted helix;

FIG. 8 is a schematic diagram that shows a density of states obtained by numerical calculation in case of U=8 in the first example of multiply-twisted helix;

FIG. 9 is a schematic diagram that shows a density of states obtained by numerical calculation in case of U=10 in the first example of multiply-twisted helix;

FIG. 10 is a schematic diagram that shows a density of states obtained by numerical calculation in case of U=12 in the first example of multiply-twisted helix;

FIG. 11 is a schematic diagram that shows a one-dimensional structure of a protein;

FIG. 12 is a schematic diagram that shows a multiply-twisted spiral as a two-dimensional structure using disulfide bonds;

FIG. 13 is a schematic diagram that shows a density of states obtained by numerical calculation in the second example of multiply-twisted helix in case of U=8 and N=2;

FIG. 14 is a schematic diagram that shows a density of states obtained by numerical calculation in the second example of multiply-twisted helix in case of U=8 and N=4;

FIG. 15 is a schematic diagram that shows a density of states obtained by numerical calculation in the second example of multiply-twisted helix in case of U=8 and N=6;

FIG. 16 is a schematic diagram that shows a density of states obtained by numerical calculation in the second example of multiply-twisted helix in case of U=8 and N=10;

FIG. 17 is a schematic diagram that shows a density of states obtained by numerical calculation in the second example of multiply-twisted helix in case of U=8 and N=20;

FIG. 18 is a schematic diagram that shows a density of states obtained by numerical calculation in the second example of multiply-twisted helix in case of U=10 and N=2;

FIG. 19 is a schematic diagram that shows a density of states obtained by numerical calculation in the second example of multiply-twisted helix in case of U=10 and N=4;

FIG. 20 is a schematic diagram that shows a density of states obtained by numerical calculation in the second example of multiply-twisted helix in case of U=10 and N=6;

FIG. 21 is a schematic diagram that shows a density of states obtained by numerical calculation in the second example of multiply-twisted helix in case of U=10 and N=10;

FIG. 22 is a schematic diagram that shows a density of states obtained by numerical calculation in the second example of multiply-twisted helix in case of U=10 and N=20;

FIG. 23 is a schematic diagram that shows a density of states obtained by numerical calculation in the second example of multiply-twisted helix in case of U=8;

FIG. 24 is a schematic diagram that shows a density of states obtained by numerical calculation in the second example of multiply-twisted helix in case of U=10;

FIG. 25 is a schematic diagram that shows a density of states obtained by numerical calculation in the second example of multiply-twisted helix in case of U=12;

FIG. 26 is a schematic diagram that shows a density of states obtained by numerical calculation in the third example of multiply-twisted helix in case of U=8;

FIG. 27 is a schematic diagram that shows a density of states obtained by numerical calculation in the third example of multiply-twisted helix in case of U=10;

FIG. 28 is a schematic diagram that shows a density of states obtained by numerical calculation in the third example of multiply-twisted helix in case of U=12;

FIG. 29 is a schematic diagram that shows changes of Ω(r) when N is changed in case of R=0 and α=0 in the fourth example of multiply-twisted helix;

FIG. 30 is a schematic diagram that shows changes of Ω(r) when R is changed in case of N=10 and α=0 in the fourth example of multiply-twisted helix;

FIG. 31 is a schematic diagram that shows changes of Ω(r) when α is changed in case of N=10 and R=0 in the fourth example of multiply-twisted helix;

FIG. 32 is a schematic diagram that shows a coefficient C₁ upon optimum approximation of Ω(r) by Equation 120 in case of R=0 and α=0 in the fourth example of multiply-twisted helix;

FIG. 33 is a schematic diagram that shows a coefficient C₂ upon optimum approximation of Ω(r) by Equation 120 in case of R=0 and α=0 in the fourth example of multiply-twisted helix;

FIG. 34 is a schematic diagram that shows a coefficient C₁ upon optimum approximation of Ω(r) by Equation 120 in case of N=10 and α=0 in the fourth example of multiply-twisted helix;

FIG. 35 is a schematic diagram that shows a coefficient C₂ upon optimum approximation of Ω(r) by Equation 120 in case of N=11 and α=0 in the fourth example of multiply-twisted helix;

FIG. 36 is a schematic diagram that shows a coefficient C₁ upon optimum approximation of Ω(r) by Equation 120 in case of N=10 and R=0 in the fourth example of multiply-twisted helix;

FIG. 37 is a schematic diagram that shows a coefficient C₂ upon optimum approximation of Ω(r) by Equation 120 in case of N=10 and R=0 in the fourth example of multiply-twisted helix;

FIG. 38 is a schematic diagram that shows changes of Ω(r) when β is changed in case of N=10 and γ=0 in a multiply-twisted helix according to the first embodiment of the invention;

FIG. 39 is a schematic diagram that shows changes of Ω(r) when β is changed in case of N=10 and γ=0.2 in the multiply-twisted helix according to the first embodiment of the invention;

FIG. 40 is a schematic diagram that shows changes of Ω(r) when β is changed in case of N=10 and γ=0.4 in a multiply-twisted helix according to the first embodiment of the invention;

FIG. 41 is a schematic diagram that shows changes of Ω(r) when β is changed in case of N=10 and γ=0.6 in the multiply-twisted helix according to the first embodiment of the invention;

FIG. 42 is a schematic diagram that shows changes of Ω(r) when β is changed in case of N=10 and γ=0.8 in the multiply-twisted helix according to the first embodiment of the invention;

FIG. 43 is a schematic diagram that shows changes of Ω(r) when β is changed in case of N=10 and γ=1 in the multiply-twisted helix according to the first embodiment of the invention;

FIG. 44 is a schematic diagram that shows a density of states obtained by numerical calculation in case of U=10, N=10 and γ=0 in the multiply-twisted helix according to the first embodiment of the invention;

FIG. 45 is a schematic diagram that shows a density of states obtained by numerical calculation in case of U=10, N=10 and γ=0.2 in the multiply-twisted helix according to the first embodiment of the invention; and

FIG. 46 is a schematic diagram that shows a density of states obtained by numerical calculation in case of U=10, N=10 and γ=0.4 in the multiply-twisted helix according to the first embodiment of the invention.

### BEST MODE FOR CARRYING OUT THE INVENTION

Before explanation of a multiply-twisted helix according to the first embodiment of the invention, explanation is made below on a multiply-twisted structure as its basic structure and some applications thereof.

First explained below is an electron system on a multiply-twisted spiral in a multiply-twisted helix.

Assuming a one-dimensional lattice, numbers are assigned as n= . . . , −1, 0, 1, . . . . The operator for generating an electron of a spin σ at the p-th lattice point is expressed by Ĉ_{p,σ}^{†}. Of course, there is the anticommutation relation

{Ĉ_{p,σ},Ĉ_{q,ρ}^{†}}=δ_{p,q}δ_{σ,ρ} (1)

Here is defined a single-band Hubbard Hamiltonian Ĥ electron system as follows.

$$\hat{H} = t {\sum }_{i , j , σ} {λ}_{i , j} {\hat{C}}_{i , σ}^{†} {\hat{C}}_{j , σ} + U {\sum }_{j} {\hat{n}}_{j , ↑} {\hat{n}}_{j , ↓} \qquad ( 2 )$$

Letting electrons be movable only among neighboring sites, as λ_{p,q}

$${λ}_{p , q} = {λ}_{q , p} = \{ \begin{matrix}1 & when & \vert p - q \vert = 1 \\ s & when & \vert p - q \vert = N \\ {s}^{2} & when & mod ( p , N ) = 0 and q = p + {N}^{2} \\ {s}^{3} & when & mod ( p , {N}^{2} ) = 1 and q = p + {N}^{3} \\ {s}^{4} & when & mod ( p , {N}^{3} ) = 2 and q = p + {N}^{4} \\ & ⋮ & \\ 0 & otherwise & \end{matrix} \qquad ( 3 )$$

is employed. Assume hereunder that s=1. However, mod (a, b) is the remainder as a result of division of a by b. Here is made a review about the average number of nearest-neighbor sites. It is

$$\begin{matrix}z = 2 + 2 + \frac{2}{N} + \frac{2}{{N}^{2}} + … & ( 4 ) \\ = 2 + \frac{2 N}{N - 1} & ( 5 )\end{matrix}$$

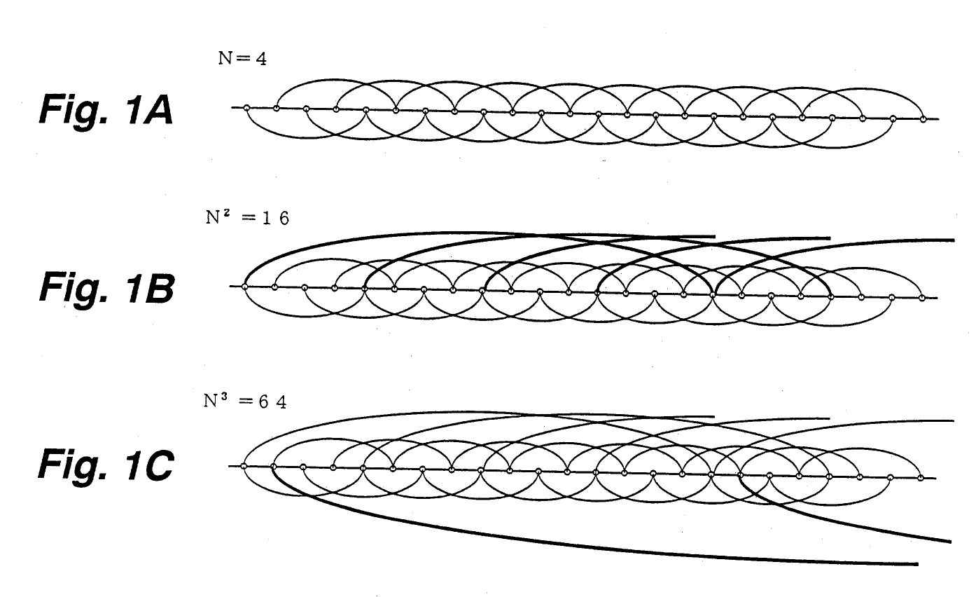

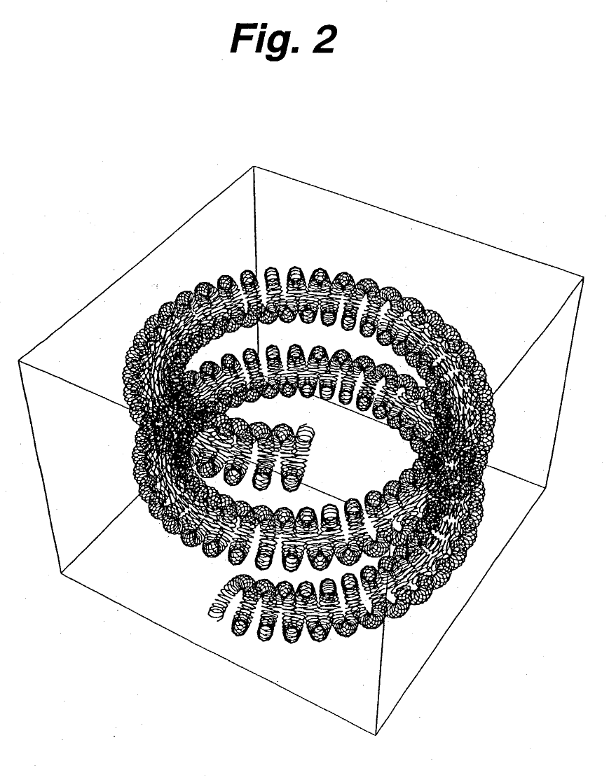

Apparently, it can be any value from the value of a three-dimensional cubic lattice, namely, z=6 when N=2, to the value of a two-dimensional square lattice, namely, z=4 when N→∞. A multiply-twisted helical structure is defined by the definition of the nearest-neighbor sites. FIG. 1 schematically show how the actual bonding appears when N=4. FIG. 1A is for N pitch, FIG. 1B is for N² pitch, and FIG. 1C is for N³ pitch. When the structure is folded such that the nearest-neighbor sites become spatially closer, the multiply-twisted spiral is obtained as shown in FIG. 2. FIG. 2, however, embellishes it to provide an easier view. In this case, the one-dimensional chain is bonded at two right and left sites, and the chain forms N pitch spirals. Since the spirals form N² pitch spirals, the term of s² enters as a result of transfer of electrons between adjacent spirals (Equation 3). Then, the spirals form spirals of a larger, i.e. N², pitch.

Here is defined a spin σ electron density operator of the j-th site, \hat{n}_{j,σ}=ĉ_{j,σ}^{†}Ĉ_{j,σ}, and the sum thereof \hat{n}ⱼ=Σ_{σ}\hat{n}_{j,σ}.

For the purpose of defining a temperature Green's function, here is introduced a grand canonical Hamiltonian \hat{K}=Ĥ−μ\hat{N} where \hat{N}=Σⱼ\hat{n}ⱼ. In the half-filled remarked here, chemical potential is μ=U/2. The half-filled grand canonical Hamiltonian can be expressed as

$$\hat{K} = t {\sum }_{i , j , σ} {λ}_{j , i} {\hat{t}}_{j , i , σ} + U / 2 {\sum }_{i} ( {\hat{u}}_{i} - 1 ) \qquad ( 6 )$$

Operators \hat{t}_{j,i,σ}, ĵ_{j,i,σ}, ûᵢ and \hat{d}_{i,σ} are defined beforehand as

\hat{t}_{j,i,σ}=ĉ_{j,σ}^{†}ĉ_{i,σ}+ĉ_{i,σ}^{†}ĉ_{j,σ} (7)

ĵ_{j,i,σ}=ĉ_{j,σ}^{†}ĉ_{i,σ}−ĉ_{i,σ}^{†}ĉ_{j,σ} (8)

ûᵢ=ĉ_{i,↑}^{†}ĉ_{i,↑}ĉ_{i,↓}^{†}ĉ_{i,↓}+ĉ_{i,↑}ĉ_{i,↑}^{†}ĉ_{i,↓}ĉ_{i,↓}^{†} (9)

\hat{d}_{i,σ}=ĉ_{i,σ}^{†}ĉ_{i,σ}−ĉ_{i,σ}ĉ_{i,σ}^{†} (10)

If the temperature Green function is defined for operators Â and \hat{B} given, taking τ as imaginary time, it is as follows.

$$⟨ \hat{A} ; \hat{B} ⟩ = - {\int }_{0}^{β} ⅆ τ ⟨ {T}_{τ} \hat{A} ( τ ) \hat{B} ⟩ {ⅇ}^{ⅈ {ω}_{n} τ} \qquad ( 11 )$$

The on-site Green function

G_{j,σ}(iωₙ)= [symbol] ĉ_{j,σ};ĉ_{j,σ}^{†} [symbol] (12)

is especially important because, when analytic continuation is conducted as iωₙ→ω+iδ for a small δ,

$${D}_{j} ( ω ) = - {\sum }_{σ = ↑ , ↓} {Im G}_{j , σ} ( ω + i δ ) \qquad ( 13 )$$

becomes the local density of states of the site j, and

$$D ( ω ) = - {\sum }_{j , σ} {Im G}_{j , σ} ( ω + i δ ) \qquad ( 14 )$$

becomes the density of states of the system. For later numerical calculation of densities of states, δ=0.0001 will be used. Further let the total number of sites be n=10001.

Imaginary time development of the system is obtained by the Heisenberg equation

$$\frac{ⅆ}{ⅆ τ} \hat{A} ( τ ) = [ \hat{K} , \hat{A} ] \qquad ( 15 )$$

As the equation of motion of the on-site Green function,

$$i {ω}_{n} ⟨ {\hat{c}}_{j , σ} ; {\hat{c}}_{j , σ}^{†} ⟩ = 1 + {t \sum }_{p , j} {λ}_{p , j} ⟨ {\hat{c}}_{p , σ} ; {\hat{c}}_{j , σ}^{†} ⟩ + \frac{U}{2} ⟨ {\hat{d}}_{j , - σ} {\hat{c}}_{j , σ} ; {\hat{c}}_{j , σ}^{†} ⟩ \qquad ( 16 )$$

is obtained. Then, the approximation shown below is introduced according to Gros ((31) C. Gros, Phys. Rev. B50, 7295(1994)). If the site p is the nearest-neighbor site of the site j, the resolution

[symbol]

ĉ_{p,σ};ĉ_{j,σ}^{†} [symbol] →t [symbol] ĉ_{p,σ};ĉ_{p,σ}^{†} [symbol] [symbol] ĉ_{j,σ};ĉ_{j,σ}^{†} [symbol] (17)

is introduced as the approximation. This is said to be exact in the case of infinite-dimensional Bethe lattices, but in the present case, it is only within approximation. Under the approximation, the following equation is obtained.

$$\begin{matrix}( i {ω}_{n} - {t}^{2} {Γ}_{j , σ} ) {G}_{j , σ} = 1 + \frac{U}{2} ⟨ {\hat{d}}_{j , - σ} {\hat{c}}_{j , σ} ; {\hat{c}}_{j , σ}^{†} ⟩ \\ where & ( 18 ) \\ {Γ}_{j , σ} = {\sum }_{p} {λ}_{p , j} {G}_{p , σ} & ( 19 )\end{matrix}$$

was introduced. To solve the equation obtained, [symbol] \hat{d}_{j,-σ}ĉ_{j,σ};ĉ_{j,σ}^{†} [symbol] must be analyzed. In case of half-filled models, this equation of motion results in

$$\begin{matrix}ⅈ {ω}_{n} ⟨ {\hat{d}}_{j , - σ} {\hat{c}}_{j , σ} ; {\hat{c}}_{j , σ}^{†} ⟩ = \frac{U}{2} {G}_{j , σ} - 2 t {\sum }_{p} {λ}_{p , j} ⟨ {\hat{j}}_{p , j , - σ} {\hat{c}}_{j , σ} ; {\hat{c}}_{j , σ}^{†} ⟩ + \\ t {\sum }_{p} {λ}_{p , j} ⟨ {\hat{d}}_{j , - σ} {\hat{c}}_{p , σ} ; {\hat{c}}_{j , σ}^{†} ⟩\end{matrix} \qquad ( 20 )$$

Here again, with reference to the Gros logic, approximation is introduced. It is the following translation.

[symbol]

ĵ_{p,j,-σ}ĉ_{j,σ};ĉ_{j,σ}^{†} [symbol] →−tG_{p,-σ} [symbol] \hat{d}_{j,-σ}ĉ_{j,σ};ĉ_{j,σ}^{†} [symbol] (21)

[symbol]

\hat{d}_{j,-σ}ĉ_{p,σ};ĉ_{j,σ}^{†} [symbol] →tG_{p,σ} [symbol] \hat{d}_{j,-σ}ĉ_{j,σ};ĉ_{j,σ}^{†} [symbol] (22)

By executing this translation, the following closed equation is obtained.

$$( i {ω}_{n} - {t}^{2} {Γ}_{j , σ} ) {G}_{j , σ} = 1 + \frac{{( U / 2 )}^{2}}{i {ω}_{n} - {t}^{2} {Γ}_{j , σ} - 2 {t}^{2} {Γ}_{j , - σ}} {G}_{j , σ} \qquad ( 23 )$$

Here is assumed that there is no dependency on spin. That is, assuming

Gⱼ=G_{j,↑}=G_{j,↓} (24)

the following calculation is executed.

Densities of States (DOS)

$$- \frac{1}{n} {\sum }_{j} {Im G}_{j} ( ω + i δ )$$

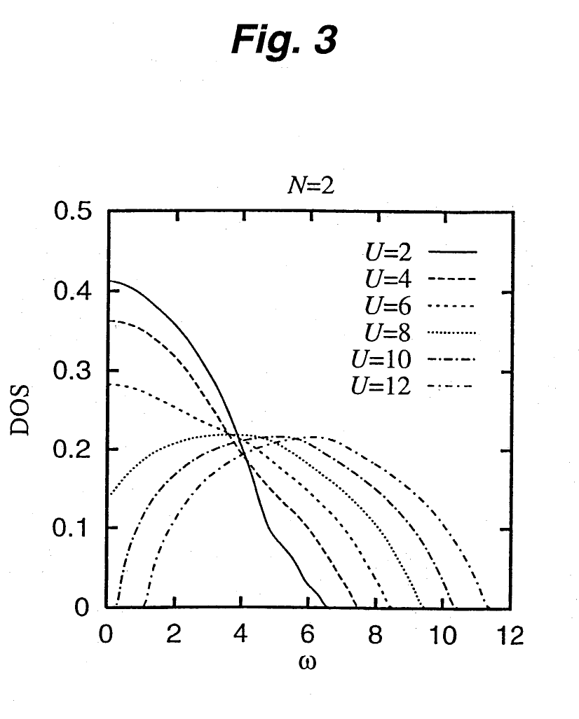

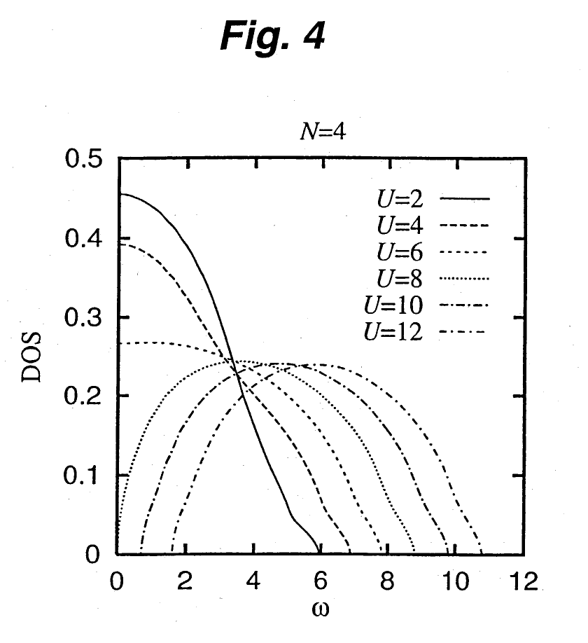

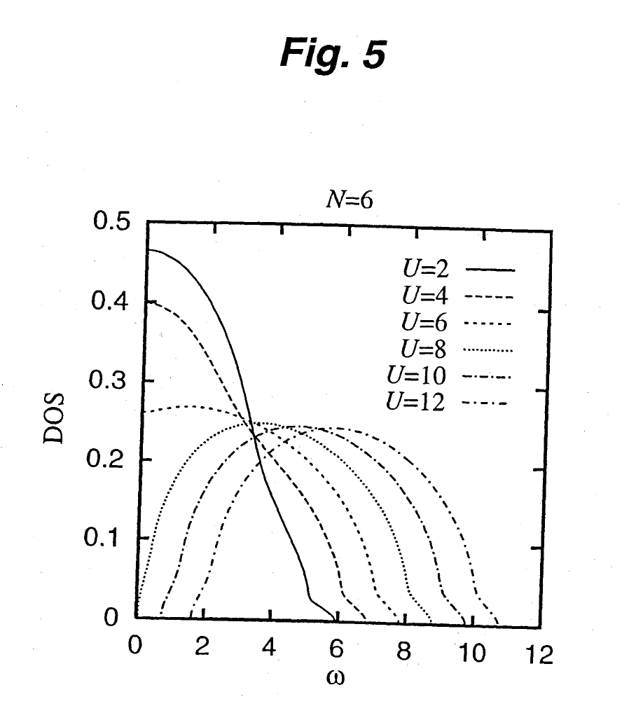

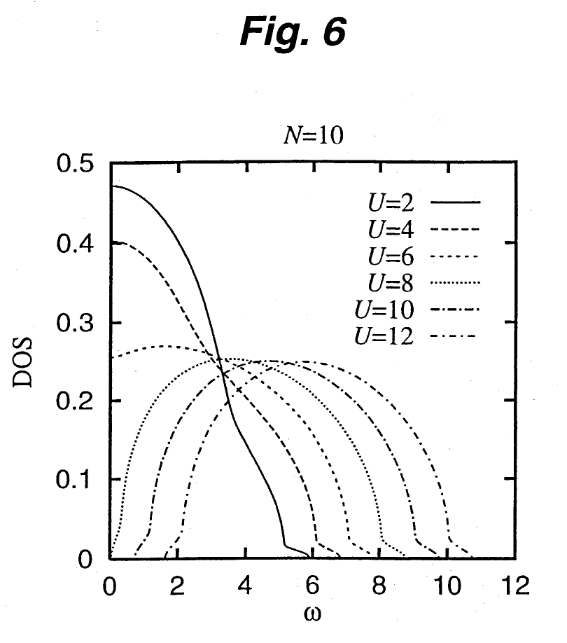

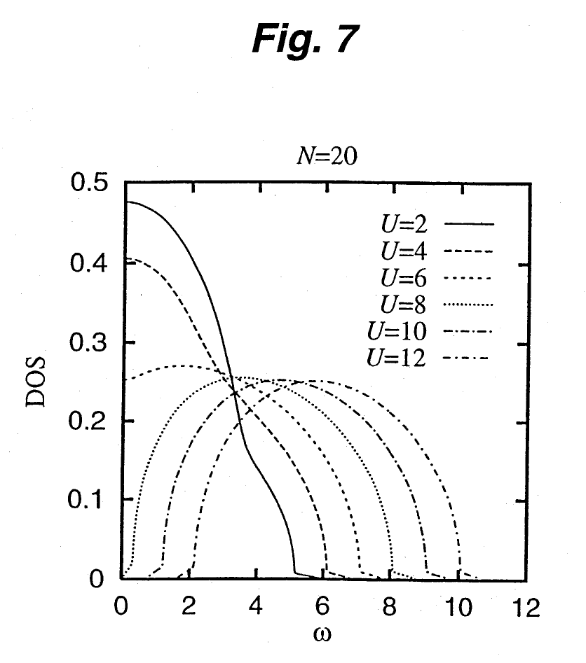

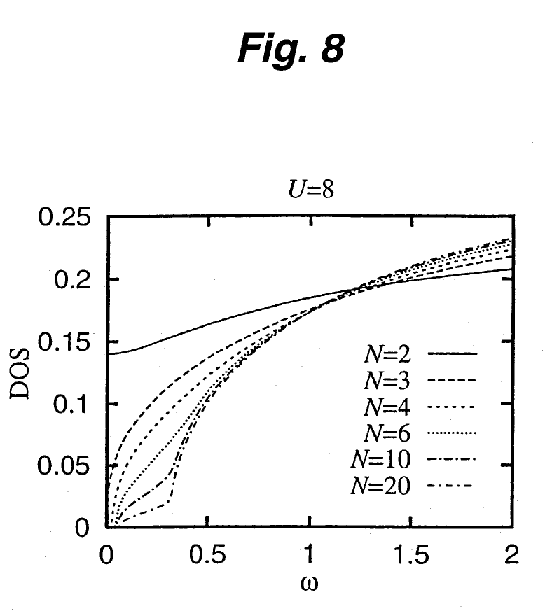

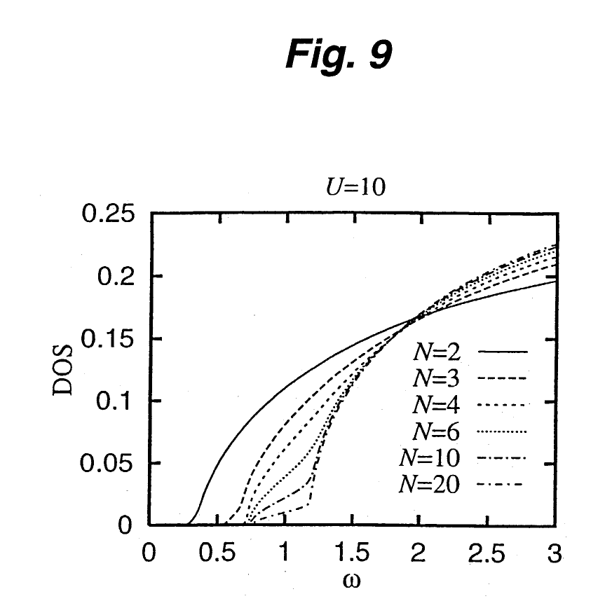

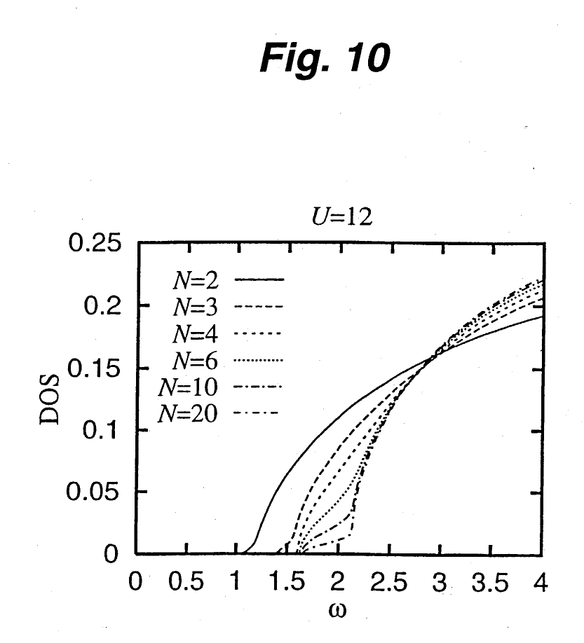

that were obtained by numerical calculation are shown below. FIG. 3 shows DOS in case of N=2. As shown in FIG. 3, when N=2, the density of state D(ω=0) under the Fermi energy ω=0 exists in case of U<8, and the system behaves as a metal. On the other hand, when U=10, there is a region having lost DOS near the Fermi energy, and the system behaves as a Mott insulator. FIG. 4 shows DOS in case of N=4. As shown in FIG. 4, when U=8, D(ω=0) becomes substantially zero, the system is closer to a Mott insulator. When the models of N=6 (FIG. 5), N=10 (FIG. 6) and N=20 (FIG. 7) are compared, this tendency is enhanced as N increases. Regarding the case of changing N while fixing U=8, DOS is shown in FIG. 8. From FIG. 8, the system is apparently a metal when N=2, and it is easily observed that a change to a Mott insulator occurs as N increases. Examples of U=10 and U=12 are shown in FIGS. 9 and 10, respectively. Since a value twice the value of ω rendering DOS be zero is the gap of a Mott insulator (Hubbard gap), it is appreciated that the width of the Hubbard gap increases with N. Therefore, it has been confirmed that Mott-Hubbard transition can be controlled by adjusting N.

In this manner, when the turn pitch is controlled and designed, the system behaves as a metal under certain conditions and as an insulator under other conditions. Therefore, a material having a plurality of regions different in turn pitch can be a superstructure having various regions including metallic regions and insulating regions, and this enables richer controls and designs of physical properties. For example, if a material is designed to have regions of metallic/insulating/metallic phases, a device behaving as a diode can be realized. If the insulator region is changeable in phase to a metal under external control, the material can behave as a transistor.

A material containing the multiply-twisted helix as a part thereof could be made. For example, a material of a multiply-twisted spiral structure added with a portion that is not a multiply-twisted spiral structure will be useful.

In the foregoing explanation, N, N² and N³ were assumed as turn pitches of multiply-twisted spirals; however, this assumption is only for simplicity, and there are various other possibilities. For example, in a p-th order spiral, it will be possible to select N^{P}+Δₚ (where Δₚ is a random number satisfying −N^{p-1}<Δₚ<N^{p-1}). This is the case where a randomness regarding positions of bonding points is introduced in a high-order spiral. This randomness gives a qualitative difference to phase transition of a system. It will be explained later in greater detail with reference to the second embodiment.

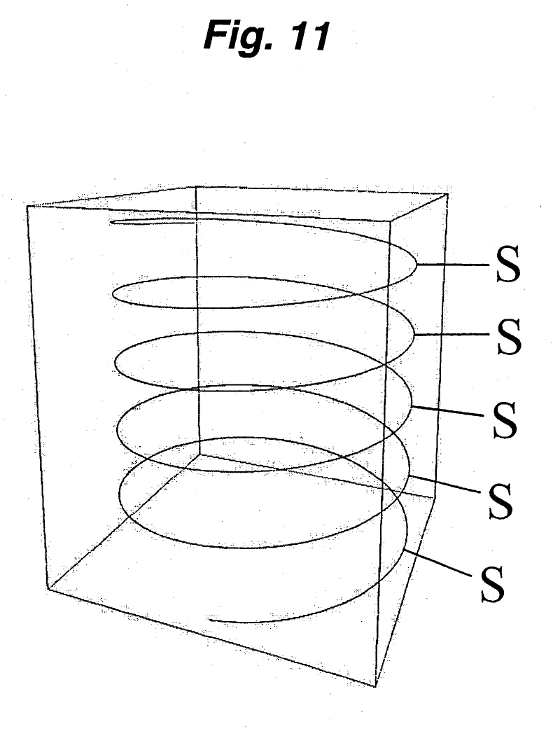

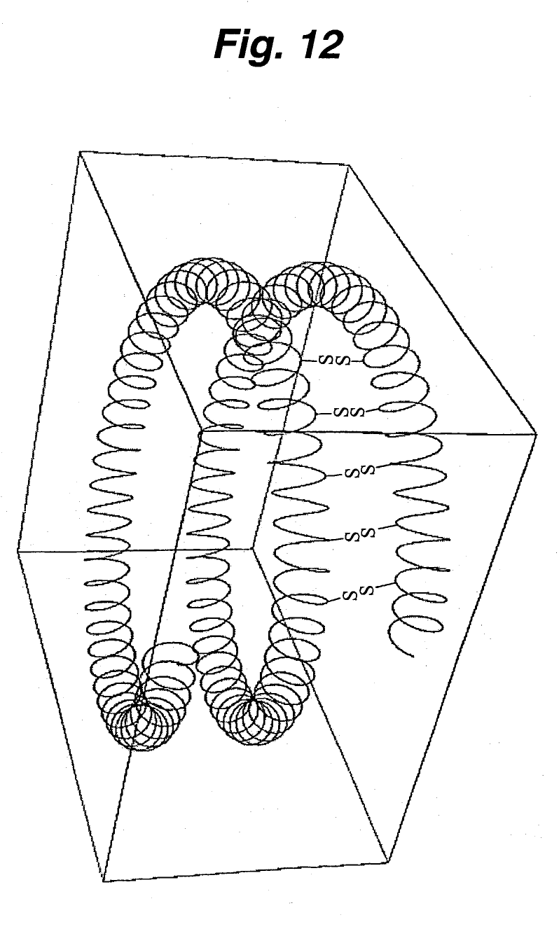

Here is explained a method of fabricating such a multiply-twisted helix. If a genetic engineering method is used, DNA having a predetermined sequence can be made. α helix is known as one of the most popular proteins. It has a spiral structure in which four amino acids form a full turn. DNA can be made such that cysteine, which is one of amino acids and has sulfur atoms, is introduced into the α helix. When this DNA is copied by mRNA to activate the genes to synthesize a protein, its primary structure is as shown in FIG. 11. On the other hand, it is known that sulfur atoms of cysteine bond one another to form a disulfide linkage, and contribute to form high-order proteins. It is expected that the multiply-twisted spirals will be formed as a secondary structure using the disulfide linkage (FIG. 12).

Next explained is a multiply-twisted helix taken as the second example of the invention. This multiply-twisted helix has introduced a randomness regarding bonding positions of spiral structures between layers.

Explained below is an electron system on a multiply-twisted spiral in the multiply-twisted helix having introduced the randomness regarding bonding positions between spiral structures of different layers.

Assuming a one-dimensional lattice, numbers are assigned as n= . . . , −1, 0, 1, . . . . The operator for generating an electron of a spin σ at the p-th lattice point is expressed by ĉ_{p,σ}^{†}. Of course, there is the anticommutation relation

{ĉ_{p,σ},ĉ_{q,ρ}^{†}}=δ_{p,q}δ_{σ,ρ} (25)

Here is defined a single-band Hubbard Hamiltonian Ĥ of the electron system as follows.

$$\hat{H} = t {\sum }_{i , j , σ} {λ}_{i , j} {\hat{c}}_{j , σ}^{†} {\hat{c}}_{j , σ} + U {\sum }_{j} {\hat{n}}_{j , ↑} {\hat{n}}_{j , ↓} \qquad ( 26 )$$

Let electrons be movable only among neighboring sites, and as λ_{p,q}

$${λ}_{p , q} = {λ}_{q , p} = \{ \begin{matrix}1 & when & \vert p - q \vert = 1 \\ s & when & \vert p - q \vert = N \\ {s}^{2} & when & mod ( p , N ) = 0 and q = p + {N}^{2} + Nr \\ {s}^{3} & when & mod ( p , {N}^{2} ) = 1 and q = p + {N}^{3} + {N}^{2} r \\ {s}^{4} & when & mod ( p , {N}^{3} ) = 2 and q = p + {N}^{4} + {N}^{3} r \\ & ⋮ & \\ 0 & otherwise & \end{matrix} \qquad ( 27 )$$

is employed. Note that mod(a, b) is the remainder as a result of division of a by b. r is a random variable that satisfies

−1<r<1 (28)

and the probability that the value of r appears is given by

$${P}_{R} ( r ) = \frac{R}{2} \vert r {\vert}^{R - 1} \qquad ( 29 )$$

Average of this distribution is zero, and dispersion is the square root of

$$\begin{matrix}⟨ {r}^{2} ⟩ = {\int }_{- 1}^{1} {r}^{2} {P}_{R} ( r ) ⅆ r & ( 30 ) \\ = \frac{1}{1 + 2 / R} & ( 31 )\end{matrix}$$

When R=1, distribution becomes uniform, and dispersion decreases as R decreases. At the limit of R→0, randomness disappears. In the following simulation, calculation is carried out for the cases of R=1, R=½, R=¼, R=⅛, R=1/16 and R=0. s=1 is used below.

Here is defined a spin σ electron density operator of the j-th site \hat{n}_{j,σ}=ĉ_{j,σ}^{†}Ĉ_{j,σ} and the sum thereof \hat{n}ⱼ=Σ_{σ}\hat{n}_{j,σ}.

For the purpose of defining a temperature Green's function, here is introduced a grand canonical Hamiltonian \hat{K}=Ĥ−μ\hat{N} where \hat{N}=Σⱼ\hat{n}_{j,}. In the half-filled remarked here, chemical potential is μ=U/2. The half-filled grand canonical Hamiltonian can be described as

$$\hat{K} = t {\sum }_{i , j , σ} {λ}_{j , i} {\hat{t}}_{j , i , σ} + U / 2 {\sum }_{i} ( {\hat{u}}_{i} - 1 ) \qquad ( 32 )$$

Operators \hat{t}_{j,i,σ}, ĵ_{j,i,σ}, ûᵢ and \hat{d}_{i,σ} are defined beforehand as

\hat{t}_{j,i,σ}=ĉ_{j,σ}^{†}ĉ_{i,σ}+ĉ_{i,σ}^{†}ĉ_{j,σ} (33)

ĵ_{j,i,σ}=ĉ_{j,σ}^{†}ĉ_{i,σ}−ĉ_{i,σ}^{†}ĉ_{j,σ} (34)

ûᵢ=ĉ_{i,↑}^{†}ĉ_{i,↑}ĉ_{i,↓}^{†}ĉ_{i,↓}+ĉ_{i,↑}ĉ_{i,↑}^{†}ĉ_{i,↓}ĉ_{i,↓}^{†} (35)

\hat{d}_{i,σ}=ĉ_{i,σ}^{†}ĉ_{i,σ}−ĉ_{i,σ}ĉ_{i,σ}^{†} (36)

Taking τ as imaginary time, the temperature Green function for operators Â and \hat{B} given can be defined as follows.

$$⟨ \hat{A} ; \hat{B} ⟩ = - {\int }_{0}^{β} ⅆ τ ⟨ {T}_{τ} \hat{A} ( τ ) \hat{B} ⟩ {ⅇ}^{ⅈ {ω}_{n} τ} \qquad ( 37 )$$

The on-site Green function

G_{j,σ}(iωₙ)= [symbol] ĉ_{j,σ};ĉ_{j,σ}^{†} [symbol] (38)

is especially important because, when analytic continuation is conducted as iωₙ→ω+iδ for a small δ,

$${D}_{j} ( ω ) = - {\sum }_{σ = ↑ , ↓} {Im G}_{j , σ} ( ω + i δ ) \qquad ( 39 )$$

describes the local density of states of the site j, and

$$D ( ω ) = - {\sum }_{j , σ} {Im G}_{j , σ} ( ω + i δ ) \qquad ( 40 )$$

describes the density of states of the system. For later numerical calculation of densities of states, δ=0.0001 will be used. The total number of sites is assumed to be n=10001.

Imaginary time development of the system is obtained by the Heisenberg equation

$$\frac{ⅆ}{ⅆ τ} \hat{A} ( τ ) = [ \hat{K} , \hat{A} ] \qquad ( 41 )$$

As the equation of motion of the on-site Green function,

$$i {ω}_{n} ⟨ {\hat{c}}_{j , σ} ; {\hat{c}}_{j , σ}^{†} ⟩ = 1 + t {\sum }_{p , j }^{} {λ}_{p , j} ⟨ {\hat{c}}_{p , σ} ; {\hat{c}}_{j , σ}^{†} ⟩ + \frac{U}{2} ⟨ {\hat{d}}_{j , - σ} {\hat{c}}_{j , σ} ; {\hat{c}}_{j , σ}^{†} ⟩ \qquad ( 42 )$$

is obtained. Then, the approximation shown below is introduced according to Gros ((31) C. Gros, Phys. Rev. B50, 7295(1994)). If the site p is the nearest-neighbor site of the site j, the resolution

[symbol]

ĉ_{p,σ};ĉ_{j,σ}^{†} [symbol] →t [symbol] ĉ_{p,σ};ĉ_{p,σ}^{†} [symbol] [symbol] ĉ_{j,σ};ĉ_{j,σ}^{†} [symbol] (43)

is introduced as the approximation. This is said to be exact in case of infinite-dimensional Bethe lattices. In this case, however, it is only within approximation. Under the approximation, the following equation is obtained.

(iωₙ−t²Γ_{j,σ})G_{j,σ}=1+U/2 [symbol] \hat{d}_{j,-σ}ĉ_{j,σ};ĉ_{j,σ}^{†} [symbol] (44)

where

$${Γ}_{j , σ} = {\sum }_{p }^{} {λ}_{p , j} {G}_{p , σ} \qquad ( 45 )$$

was introduced. To solve the equation obtained, [symbol] \hat{d}_{j,-σ}ĉ_{j,σ};ĉ_{j,σ}^{†} [symbol] must be analyzed. In case of half-filled models, this equation of motion is

$$\begin{matrix}i {ω}_{n} ⟨ {\hat{d}}_{j , - σ} {\hat{c}}_{j , σ} ; {\hat{c}}_{j , σ}^{†} ⟩ = \frac{U}{2} {G}_{j , σ} - 2 t {\sum }_{p }^{} {λ}_{p , j} ⟨ {\hat{j}}_{p , j , - σ} {\hat{c}}_{j , σ} ; {\hat{c}}_{j , σ}^{†} ⟩ + \\ t {\sum }_{p }^{} {λ}_{p , j} ⟨ {\hat{d}}_{j , - σ} {\hat{c}}_{p , σ} ; {\hat{c}}_{j , σ}^{†} ⟩\end{matrix} \qquad ( 46 )$$

Here again, with reference to the Gros logic, approximation is introduced. It is the translation shown below.

[symbol]

ĵ_{p,j,-σ}ĉ_{j,σ};ĉ_{j,σ}^{†} [symbol] →−tG_{p,-σ} [symbol] \hat{d}_{j,-σ}ĉ_{j,σ};ĉ_{j,σ}^{†} [symbol] (47)

[symbol]

\hat{d}_{j,-σ}ĉ_{p,σ};ĉ_{j,σ}^{†} [symbol] →tG_{p,σ} [symbol] \hat{d}_{j,-σ}ĉ_{j,σ};ĉ_{j,σ}^{†} [symbol] (48)

By executing this translation, the following closed equation is obtained.

$$( i {ω}_{n} - {t}^{2} {Γ}_{j , σ} ) {G}_{j , σ} = 1 + \frac{{( U / 2 )}^{2}}{i {ω}_{n} - {t}^{2} {Γ}_{j , σ} - 2 {t}^{2} {Γ}_{j , - σ}} {G}_{j , σ} \qquad ( 49 )$$

Here is assumed that there is no dependency on spin. That is, assuming

Gⱼ=G_{j,↑}=G_{j,↓} (50)

the following calculation is carried out. In the models remarked here, there exist three parameters of R that determine electron interaction U, turn pitch N and random distribution. Although t=1, generality is not lost.

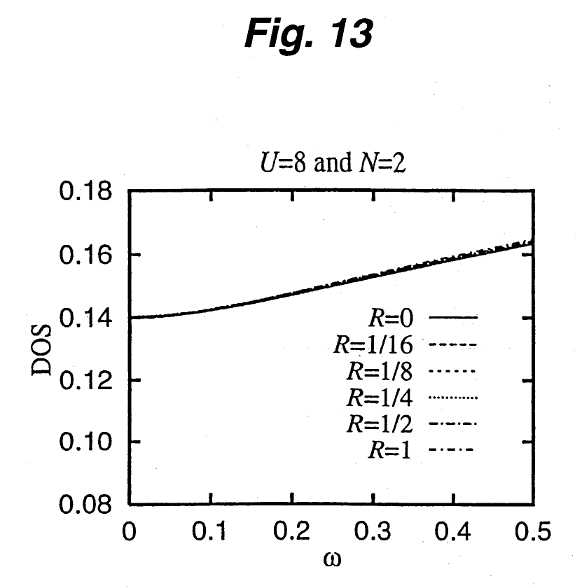

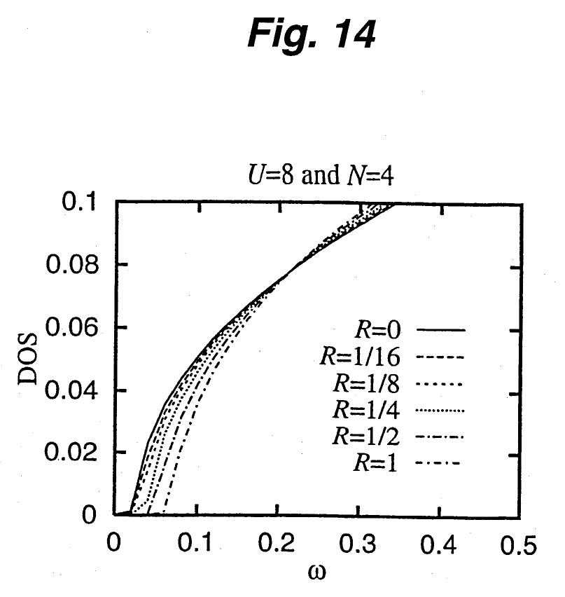

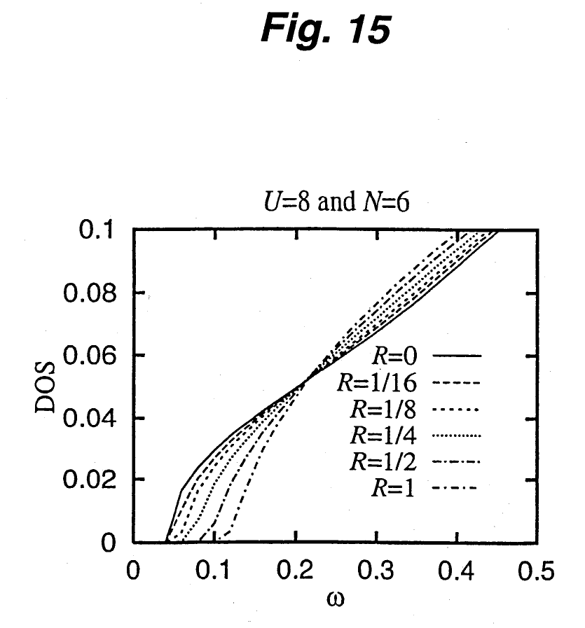

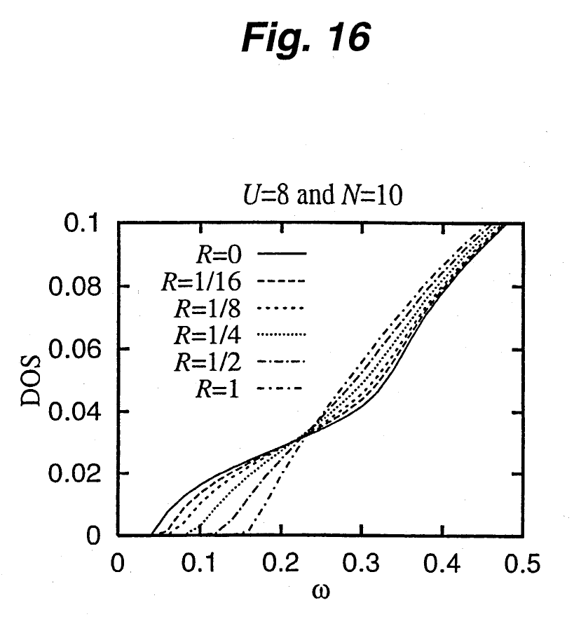

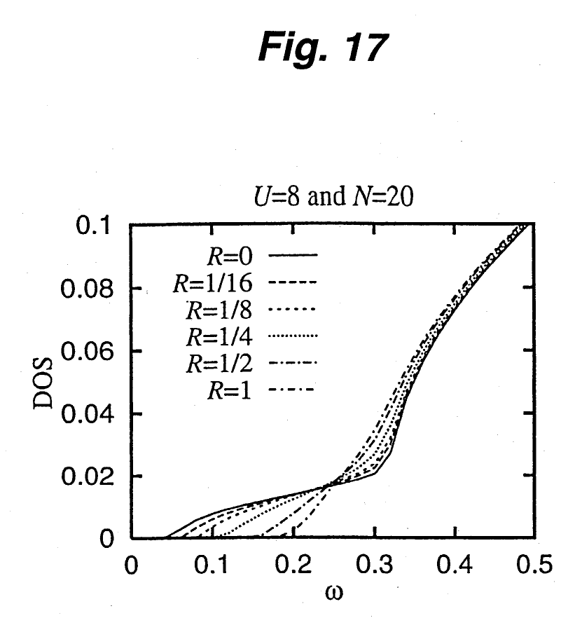

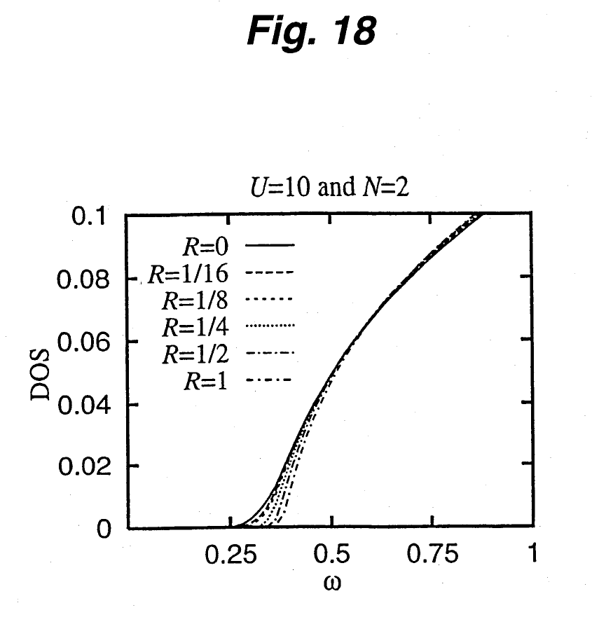

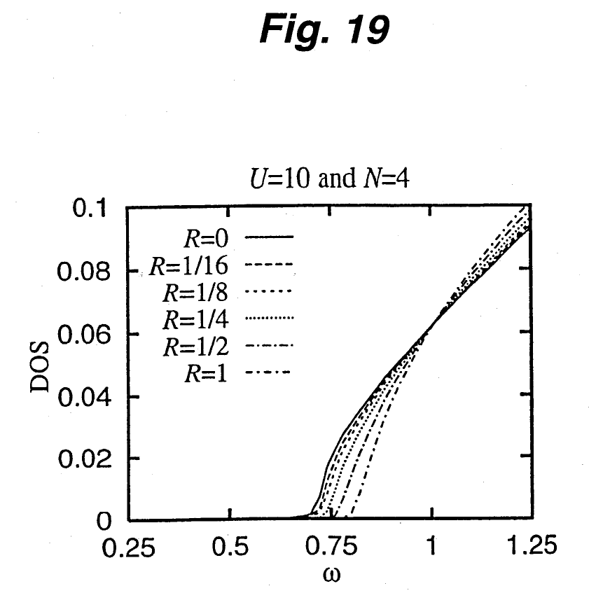

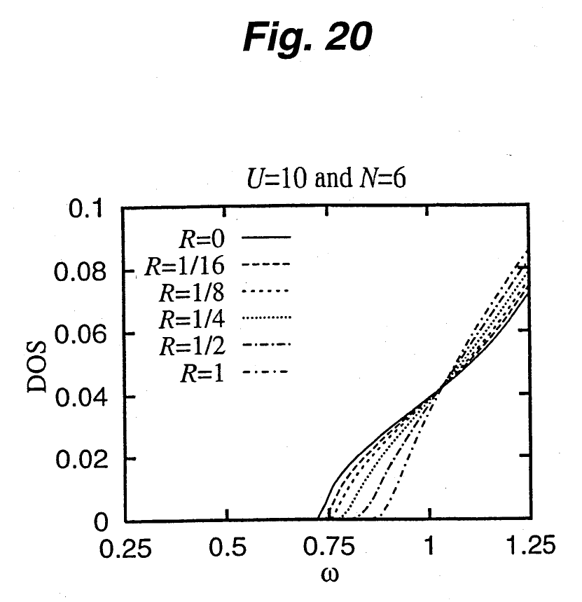

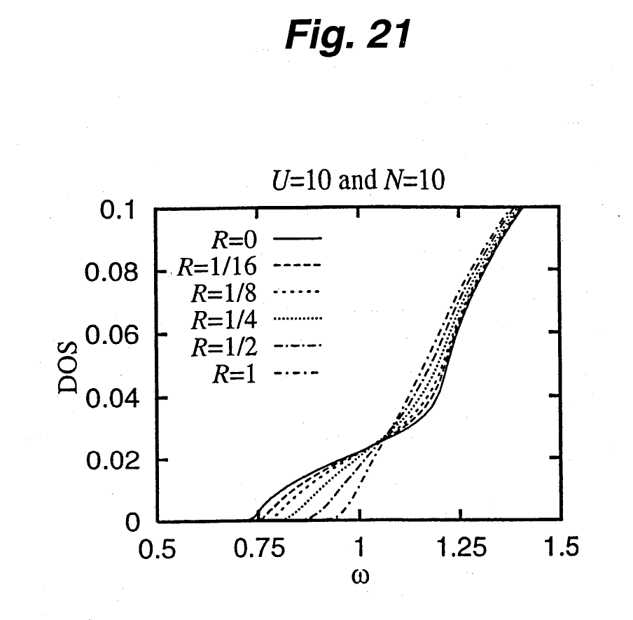

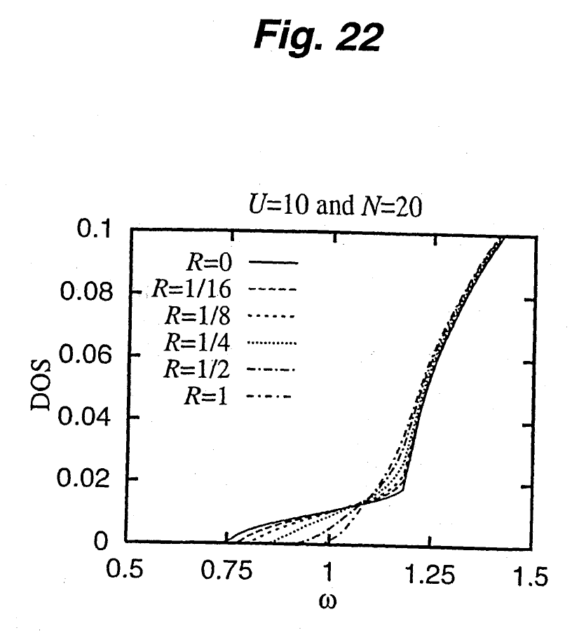

Here are discussed effects of randomness. Aspects of DOS under U=8 are shown in FIG. 13 (N=2), FIG. 14 (N=4), FIG. 15 (N=6), FIG. 16 (N=10), and FIG. 17 (N=20). As R increases, randomness also increases. Randomness gives almost no influences to metallic states (FIG. 13). As N increases and the nature of multiply-twisted helix is introduced, a tail appears on DOS under R=0. This tail narrows the Hubbard gap, but as the randomness increases, the tail disappears and the insulation performance increases, as understood from the figure. Aspects of DOS under U=10 are shown in FIG. 18 (N=2), FIG. 19 (N=4), FIG. 20 (N=6), FIG. 21 (N=10), and FIG. 22 (N=20). In FIG. 18, it should be remarked that influences of randomness are not so large. In this case, the system is already a Mott insulator, but the value of N is small. Therefore, there exists no tail structure derived from the multiply-twisted helical structure. On the other hand, as N increases, a tail is produced, and thereafter disappears due to randomness as understood from the figure.

This manner of control and design of the turn pitch has been confirmed to cause the system to behave as a metal under certain conditions and as an insulator under other conditions with the insulative property enhanced by randomness.

For the purpose of comparison with a system in which randomness has been introduced to bonds between different layers of the multiply-twisted helical structure of different layers, an absolute random-bonding system was analyzed. It is targeted to Mott transition on lattices in which bonds are formed absolutely randomly under the constraint that each of 10001 sites has at least four nearest-neighbor sites. As the average, the number of nearest-neighbor sites was determined as

Z=4+L/5 (51)

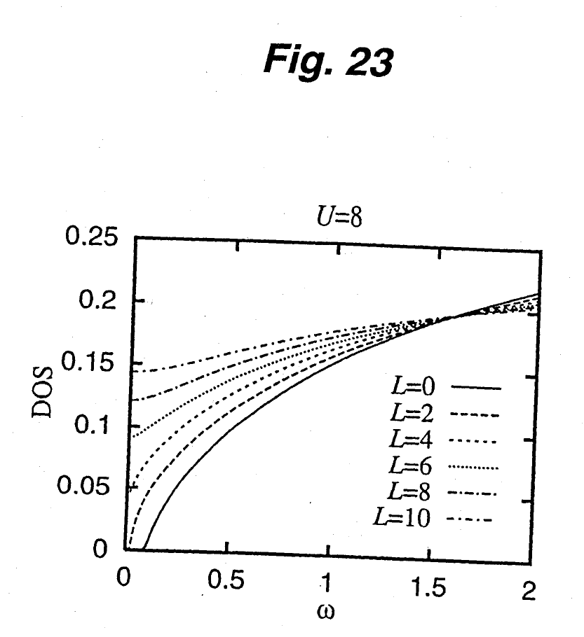

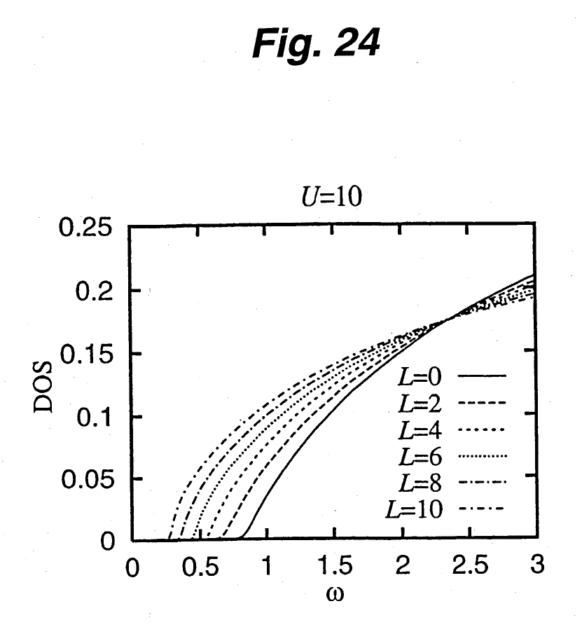

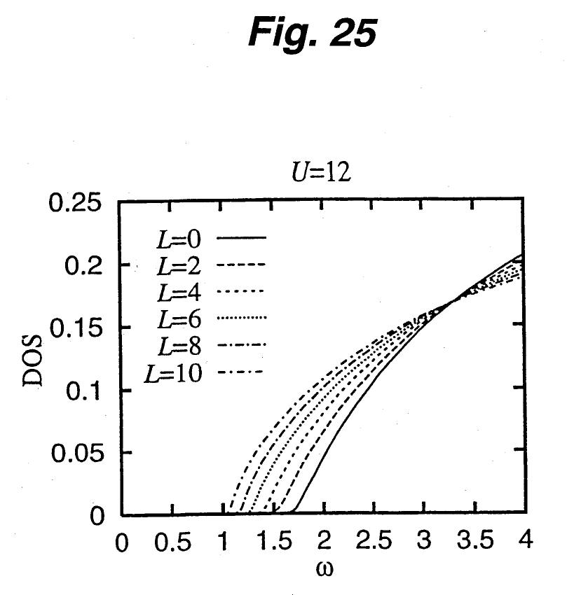

Therefore, when L=0, it becomes a number of nearest-neighbor sites equivalent to that of a two-dimensional square lattice. When L=10, it becomes a number of nearest-neighbor sites equivalent to that of a three-dimensional cubic lattice. Aspects of DOS of this random-bonding system are shown in FIG. 23 (U=8), FIG. 24 (U=10) and FIG. 25 (U=12). Changes of DOS are smooth, apparently unlike the foregoing multiply-twisted helical structure.

Next explained is a multiply-twisted helix taken as the third example of invention. This multiply-twisted helix is of the type that controls Mott-Hubbard metal-insulator transition by controlling bonding positions of spiral structures of different layers.

An electron system on a multiply-twisted spiral in the multiply-twisted helix according to the third example is explained below.

Assuming a one-dimensional lattice, numbers are assigned as n= . . . , −1, 0, 1, . . . . The operator for generating an electron of a spin σ at the p-th lattice point is expressed by ĉ_{p,σ}^{†}. Of course, there is the anticommutation relation

{ĉ_{p,σ},ĉ_{q,ρ}^{†}}=δ_{p,q}δ_{σ,ρ} (52)

Here is defined a single-band Hubbard Hamiltonian Ĥ of the electron system as follows.

$$\hat{H} = t {\sum }_{i , j , σ }^{} {λ}_{i , j} {\hat{c}}_{i , σ}^{†} {\hat{c}}_{j , σ} + U {\sum }_{j} {n}_{j , ↑} {n}_{j , ↓} \qquad ( 53 )$$

Assume here that electrons are movable only among neighboring sites, and the following definition is employed as λ_{p,q}.

$${λ}_{p , q} = {λ}_{q , p} = \{ \begin{matrix}1 & when & \vert p - q \vert = 1 \\ s & when & \vert p - q \vert = N \\ {s}^{2} & when & mod ( p , N ) = 0 and q = p + {N}^{2} + f ( N ) \\ {s}^{3} & when & mod ( p , {N}^{2} ) = 1 and q = p + {N}^{3} + f ( {N}^{2} ) \\ {s}^{4} & when & mod ( p , {N}^{3} ) = 2 and q = p + {N}^{4} + f ( {N}^{3} ) \\ & ⋮ & \\ 0 & otherwise & \end{matrix} \qquad ( 54 )$$

Note that mod(a, b) is the remainder as a result of division of a by b. In this definition, an arbitrary function f(x) is introduced to provide a generalized model. For example, a model given by

ƒ(x)=0 (55)

is the model analyzed in the multiply-twisted helix taken as the first example. On the other hand, a model given by

ƒ(x)=rx (56)

where r is a random variable that satisfies

−1<r<1 (57)

and in which values of r appear with the probability given by

$${P}_{R} ( r ) = \frac{R}{2} \vert r {\vert}^{R - 1} \qquad ( 58 )$$

is the model analyzed in the multiply-twisted helix taken as the second example.

The target of analysis in the multiply-helix structure according to the third example is the model specifying

ƒ(x)=Ωx (59)

by Ω=−1/2. That is, here is taken a model based on the multiply-twisted helix according to the second example but fixed in random variable r at −1/2. In other words, bonds between layers can be regarded as moving in parallel as a whole, relative to the system of f(x)=0.

Here is defined a spin σ electron density operator of the j-th site \hat{n}_{j,σ}=ĉ_{j,σ}^{†}ĉ_{j,σ} and its sum \hat{n}ⱼ=Σ_{σ}\hat{n}_{j,σ}.

For the purpose of defining the temperature Green's function, here is introduced a grand canonical Hamiltonian \hat{K}=Ĥ−μ\hat{N} where \hat{N}=Σⱼ\hat{n}ⱼ. In the half-filled taken here, chemical potential is μ=U/2. The half-filled grand canonical Hamiltonian can be expressed as

$$\hat{K} = t {\sum }_{i , j , σ }^{} {λ}_{j , i} {\hat{t}}_{j , i , σ} + U / 2 {\sum }_{i} ( {\hat{u}}_{i} - 1 ) \qquad ( 60 )$$

Operators\hat{t}_{j,i,σ}, ĵ_{j,i,σ}, ûᵢ and \hat{d}_{i,σ} are defined beforehand as

\hat{t}_{j,i,σ}=ĉ_{j,σ}^{†}ĉ_{i,σ}+ĉ_{i,σ}^{†}ĉ_{j,σ} (61)

ĵ_{j,i,σ}=ĉ_{j,σ}^{†}ĉ_{i,σ}−ĉ_{i,σ}^{†}ĉ_{j,σ} (62)

ûᵢ=ĉ_{i,↑}^{†}ĉ_{i,↑}ĉ_{i,↓}^{†}ĉ_{i,↓}+ĉ_{i,↑}ĉ_{i,↑}^{†}ĉ_{i,↓}ĉ_{i,↓}^{†} (63)

\hat{d}_{i,σ}=ĉ_{i,σ}^{†}ĉ_{i,σ}−ĉ_{i,σ}ĉ_{i,σ}^{†} (64)

If the temperature Green function is defined for operators Â and \hat{B} given, taking τ as imaginary time, it is as follows.

[symbol]

Â;\hat{B} [symbol] =−∫₀^{β}dτ [symbol] T_{τ}Â(τ)\hat{B} [symbol] e^{iω}^{ₙ}^{τ} (65)

The on-site Green function

G_{j,σ}(iωₙ)= [symbol] ĉ_{j,σ};ĉ_{j,σ}^{†} [symbol] (66)

is especially important because, when analytic continuation is conducted as iωₙ→ω+iδ for a small δ,

$${D}_{j} = ( ω ) = - {\sum }_{σ = ↑ , ↓} {Im G}_{j , σ} ( ω + i δ ) \qquad ( 67 )$$

becomes the local density of states of the site j, and

$$D ( ω ) = - {\sum }_{j , σ} {Im G}_{j , σ} ( ω + i δ ) \qquad ( 68 )$$

becomes the density of states of the system. For later numerical calculation of densities of states, δ=0.0001 will be used. Let the total number of sites be n=10001.

Imaginary time development of the system is obtained by the Heisenberg equation

$$\frac{ⅆ}{ⅆ τ} \hat{A} ( τ ) = [ \hat{K} , \hat{A} ] \qquad ( 69 )$$

As the equation of motion of the on-site Green function,

$$ⅈ {ω}_{n} ⟨ {\hat{c}}_{j , σ} ; {\hat{c}}_{j , σ}^{†} ⟩ = 1 + t {\sum }_{p , j} {λ}_{p , j} ⟨ {\hat{c}}_{p , σ} ; {\hat{c}}_{j , σ}^{†} ⟩ + \frac{U}{2} ⟨ {\hat{d}}_{j , - σ} {\hat{c}}_{j , σ} ; {\hat{c}}_{j , σ}^{†} ⟩ \qquad ( 70 )$$

is obtained. Then, the approximation shown below is introduced, following Gros ((31) C. Gros, Phys. Rev. B50, 7295(1994)). If the site p is the nearest-neighbor site of the site j, the resolution

[symbol]

ĉ_{p,σ};ĉ_{j,σ}^{†} [symbol] →t [symbol] ĉ_{p,σ};ĉ_{p,σ}^{†} [symbol] [symbol] ĉ_{j,σ};ĉ_{j,σ}^{†} [symbol] (71)

is introduced as the approximation. This is said to be exact in case of infinite-dimensional Bethe lattices, but in this case, it is only within approximation. Under the approximation, the following equation is obtained.

$$\begin{matrix}( {ⅈω}_{n} - {t}^{2} {Γ}_{j , σ} ) {G}_{j , σ} = 1 + \frac{U}{2} ⟨ {\hat{d}}_{j , - σ} {\hat{c}}_{j , σ} ; {\hat{c}}_{j , σ}^{†} ⟩ \\ where & ( 72 ) \\ {Γ}_{j , σ} = {\sum }_{p} {λ}_{p , j} {G}_{p , σ} & ( 73 )\end{matrix}$$

was introduced. To solve the equation obtained, [symbol] \hat{d}_{j,-σ}ĉ_{j,σ};ĉ_{j,σ}^{†} [symbol] must be analyzed. In case of half-filled models, this equation of motion is

$$\begin{matrix}ⅈ {ω}_{n} ⟨ {\hat{d}}_{j , - σ} {\hat{c}}_{j , σ} ; {\hat{c}}_{j , σ}^{†} ⟩ = \frac{U}{2} {G}_{j , σ} - 2 t {\sum }_{p} {λ}_{p , j} ⟨ {\hat{j}}_{p , j , - σ} {\hat{c}}_{j , σ} ; {\hat{c}}_{j , σ}^{†} ⟩ + \\ t {\sum }_{p} {λ}_{p , j} ⟨ {\hat{d}}_{j , - σ} {\hat{c}}_{p , σ} ; {\hat{c}}_{j , σ}^{†} ⟩\end{matrix} \qquad ( 74 )$$

Here again, with reference to the Gros logic, approximation is introduced. It is the following translation.

[symbol]

ĵ_{p,j,-σ}ĉ_{j,σ};ĉ_{j,σ}^{†} [symbol] →−tG_{p,-σ} [symbol] \hat{d}_{j,-σ}ĉ_{j,σ};ĉ_{j,σ}^{†} [symbol] (75)

[symbol]

\hat{d}_{j,-σ}ĉ_{p,σ};ĉ_{j,σ}^{†} [symbol] →tG_{p,σ} [symbol] \hat{d}_{j,-σ}ĉ_{j,σ};ĉ_{j,σ}^{†} [symbol] (76)

By executing this translation, the following closed equation is obtained.

$$( ⅈ {ω}_{n} - {t}^{2} {Γ}_{j , σ} ) {G}_{j , σ} = 1 + \frac{{( U / 2 )}^{2}}{ⅈ {ω}_{n} - {t}^{2} {Γ}_{j , σ} - 2 {t}^{2} {Γ}_{j , - σ}} {G}_{j , σ} \qquad ( 77 )$$

Here is assumed that there is no dependency on spin. That is, assuming

Gⱼ=G_{j,↑}=G_{j,↓} (78)

the following calculation is carried out. In the models taken here, there exist parameters of the electron interaction U and the turn pitch N. For the following calculation, s=t=1 is used.

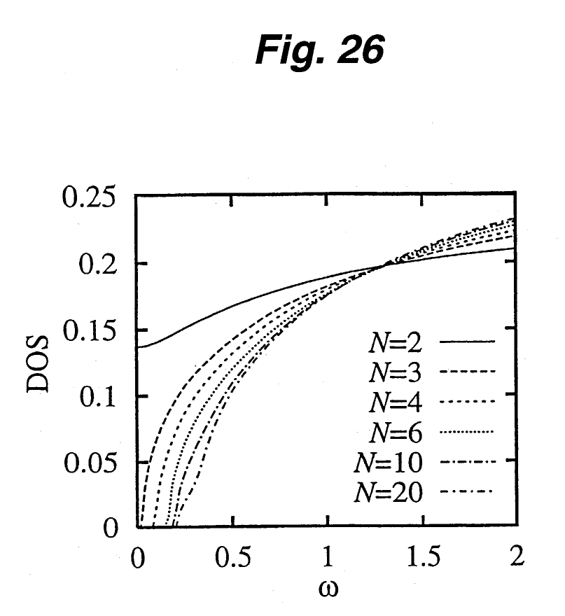

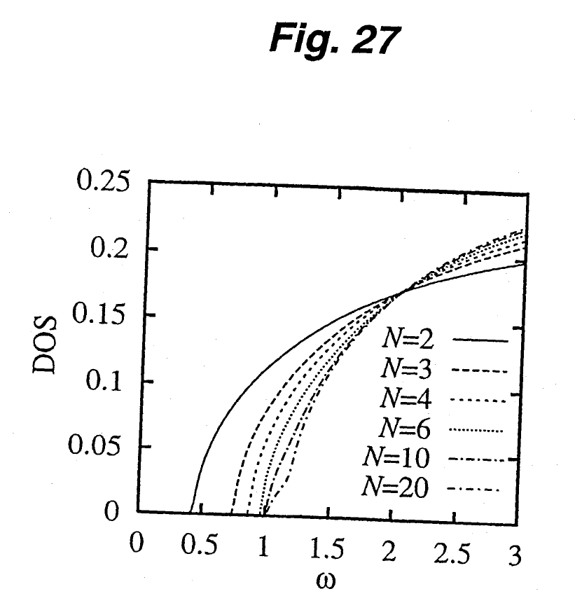

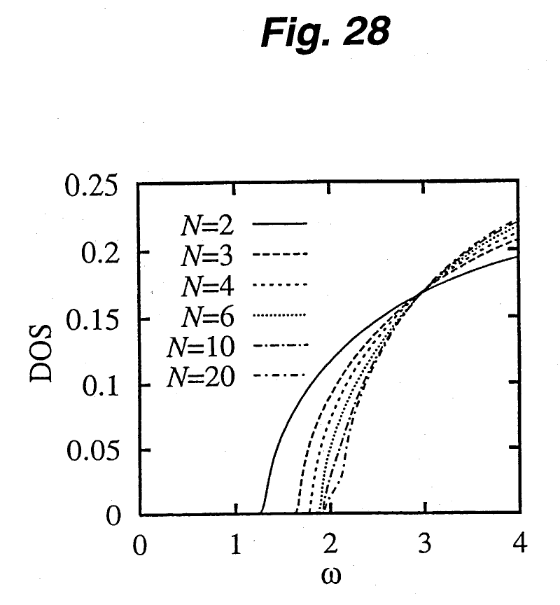

Let discussion be progressed to a case using f(x)=−x/2. Aspects of DOS under N=2, 3, 4, 6, 10, 20 are shown in FIG. 26 (U=8), FIG. 27 (U=10) and FIG. 28 (U=12). It will be appreciated that the Mott transition is qualitatively controlled by N similarly to FIG. 8. However, they are different quantitatively. Especially, the Hubbard band tail structure remarkable under larger values of N is small in FIG. 27. Therefore, it is possible to modify the electron state in the multiply-twisted helix by changing Ω in f(x)=Ωx.

Next explained is a multiply-twisted helix as the fourth example of the invention. In the fourth example, a simple cellular automaton is assumed in the multiply-twisted structure, and a simulation of its dynamics is carried out to introduce spacing between elements. Based on the spacing, bondability of distant elements is investigated to demonstrate that the bondability can be modified.

Assuming a one-dimensional lattice made up of elements, numbers are assigned as p= . . . , −1, 0, 1, . . . . A multiply-twisted helix is defined by the bondability between elements. For the purpose of defining nearest-neighbor elements,

$${J}_{p , q} = {J}_{q , p} = \{ \begin{matrix}1 & when & \vert p - q \vert = 1 \\ s & when & \vert p - q \vert = N \\ {s}^{2} & when & mod ( p , N ) = 0 and q = p + {N}^{2} + f ( N ) \\ {s}^{3} & when & mod ( p , {N}^{2} ) = 1 and q = p + {N}^{3} + f ( {N}^{2} ) \\ {s}^{4} & when & mod ( p , {N}^{3} ) = 2 and q = p + {N}^{4} + f ( {N}^{3} ) \\ & ⋮ & \\ 0 & otherwise & \end{matrix} \qquad ( 79 )$$

is introduced, and s=1 is used hereunder. Assume that the p-th element and the q-th element are the nearest-neighbor elements when J_{p,q}=1. The following function is employed as f(x).

ƒ(x)=sign(rx)int(|rx|)−int(αx) (80)

The following definition was used here.

$$sign ( x ) = \{ \begin{matrix}1 & when x \geq 0 \\ - 1 & when x < 0\end{matrix} \qquad ( 81 )$$

The term int(x) is the largest integer that does not exceed x. r is the random variable that satisfies

−1<r<1 (82)

and let the r value appearance probability be given by

$${P}_{R} ( r ) = \frac{R}{2} \vert r {\vert}^{R - 1} \qquad ( 83 )$$

R is the parameter that characterizes the probability distribution. Although the average value of the distribution is always <r>=0, self multiplication of dispersion is given by

$$⟨ {r}^{2} ⟩ = {\int }_{- 1}^{1} ⅆ {rr}^{2} {P}_{R} ( r ) = \frac{1}{1 + 2 / R} \qquad ( 84 )$$

and dispersion increases as R increases. Under R=0, randomness disappears. On the other hand, in case of R=1, the distribution becomes uniform, and the randomness is largest in the model. The random variable is generated for each bond between layers, and randomness is introduced to bonding positions, thereby to produce the multiply-twisted helix to be analyzed. α>0 causes parallel movement of the distribution. In the multiply-twisted helix, there are parameters of the turn pitch N, distribution width R of bonds between layers, distribution position α of bonds between layers.

Analysis made below is to introduce a certain sense of spacing between sites that are not nearest-neighbor sites and to measure the bondability between sites on the basis of the number of sites existing at the distance from a certain site. For this purpose, a simple cellular automaton (CA) is introduced. A variable of σₙ=1 or 0 is introduced to the n-th site. Let this variable be capable of varying with time t=0, 1, . . . , and let it written as σₙ(t).

As the initial condition,

$${σ}_{n} ( 0 ) = \{ \begin{matrix}1 & when & n = p \\ 0 & when & n \neq p\end{matrix} \qquad ( 85 )$$

is used. As the CA dynamics,

$${σ}_{n} ( t + 1 ) = Θ ( {\sum }_{m} {J}_{n , m} {σ}_{m} ( t ) ) \qquad ( 86 )$$

is used, where

$$Θ ( x ) = \{ \begin{matrix}1 & when & x > 0 \\ 0 & when & x \leq 0\end{matrix} \qquad ( 87 )$$

Through this time development, the time t when the q-th site first becomes σ_{q}(t)=1 is used to define the distance Δ_{p, q} between the p-th site and the q-th site.

A physical interpretation is given beforehand to the distance Δ_{p, q}. There are a plurality of paths connecting the p-th site and the q-th site via the nearest-neighbor sites, and the shortest one is the aforementioned distance. In a continuous three-dimensional space (x, y, z), it corresponds to a case where |x|+|y|+|z| is employed as the distance from the origin. In CA mentioned above, propagation to the nearest-neighbor site occurs during the time width 1, and the time required for σₚ(0)=1 having localized in the p-th site to reach the q-th site was measured to be used as the distance. Of course, the distance introduced here satisfies the axioms

Δ_{p,q}≧0 (88)

Δ_{p,q}=Δ_{q,p} (89)

Δ_{p,r}≦Δ_{p,q}+Δ_{q,r}

Δ_{p,q}=0 [symbol] p=q (90)

By execution of this CA simulation, arbitrary (p, q) distance can be determined.

The quantity remarked in this fourth example is the total number ω(r; pⱼ) of sites q at the distance Δ_{pj, q}=r from an arbitrary pⱼ-th site. What is calculated below is the quantity

$$Ω ( r ) = \frac{1}{{M}_{s}} {\sum }_{j = 1}^{{M}_{s}} ω ( r ; {p}_{j} ) \qquad ( 91 )$$

to be obtained by using a multiply-twisted structure made up of M=10001 sites and averaging Mₛ=1000 samples selected as pⱼ sites from them. It will be readily understood that this quantity becomes

Ω(r)=Const.+4r² (92)

in case of a three-dimensional cubic lattice.

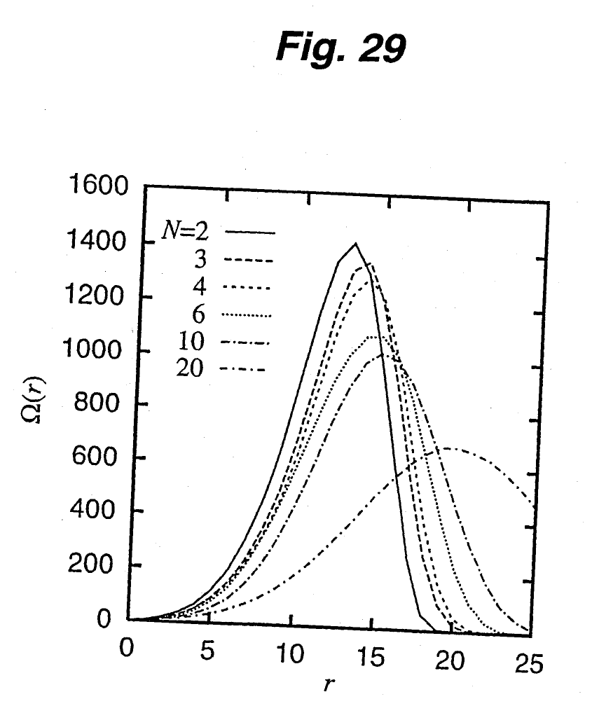

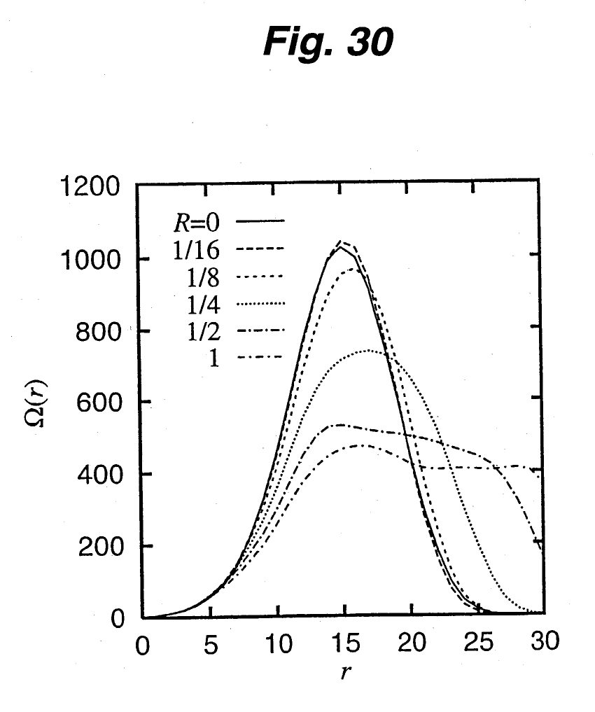

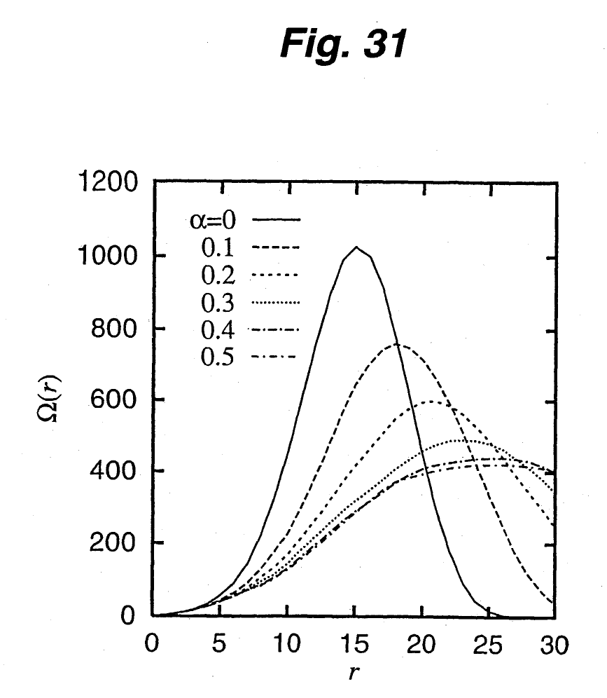

Ω(r) in the multiply-twisted helix will be calculated below. In FIG. 29, Ω(r) in case of R=0 and α=0 was plotted for various values of N. This system is a multiply-twisted helix similar to that taken for analysis of Mott transition in the first example. In FIG. 30, Ω(r) in case of N=10 and α=0 was plotted for various values of R. This system is a multiply-twisted helix similar to that taken for analysis of Mott transition in the second example. In FIG. 31, Ω(r) in case of N=10 and R=0 was plotted for various values of α. This system is a multiply-twisted helix similar to that taken for analysis of Mott transition in the third example. In these figures, Ω(r) in a region of the level of r<10 is described well by quadratic functions of r. Hereunder, this is generally developed as

Ω(r)=C₀+C₁r²+C₂r⁴ (93)

and discussed while using coefficients C₁ and C₂.

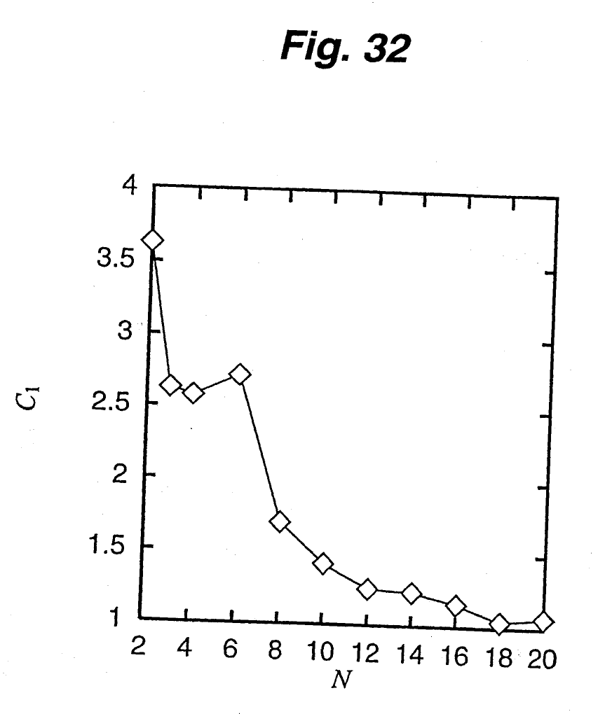

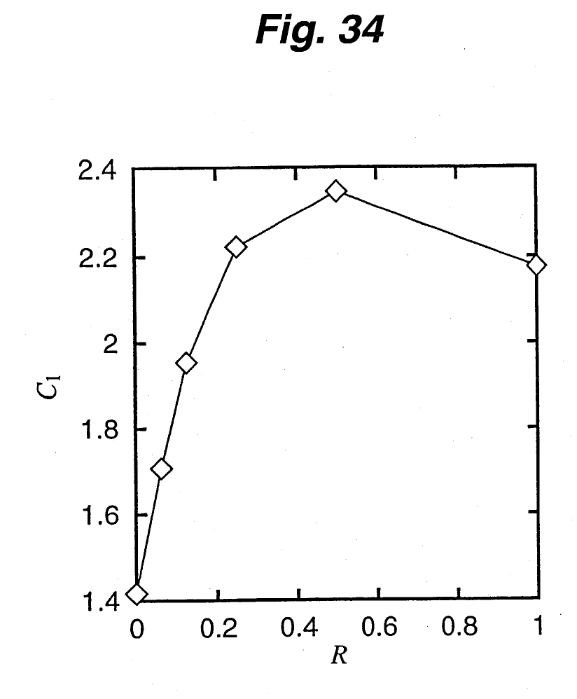

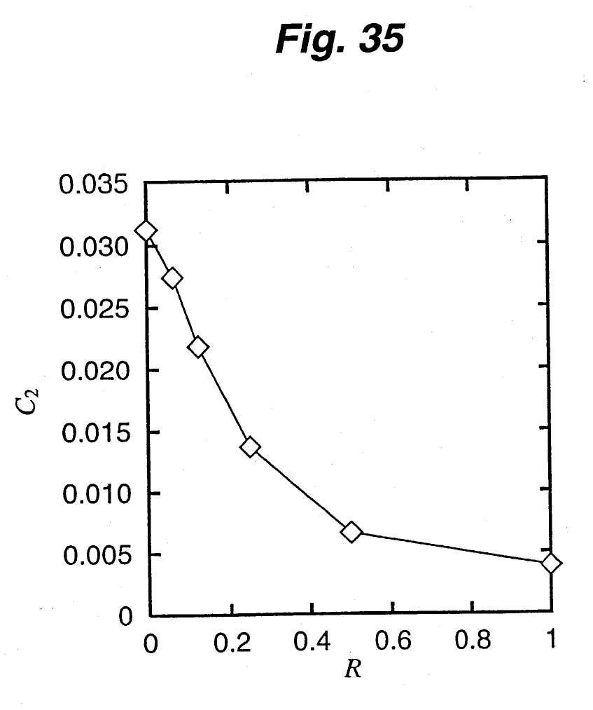

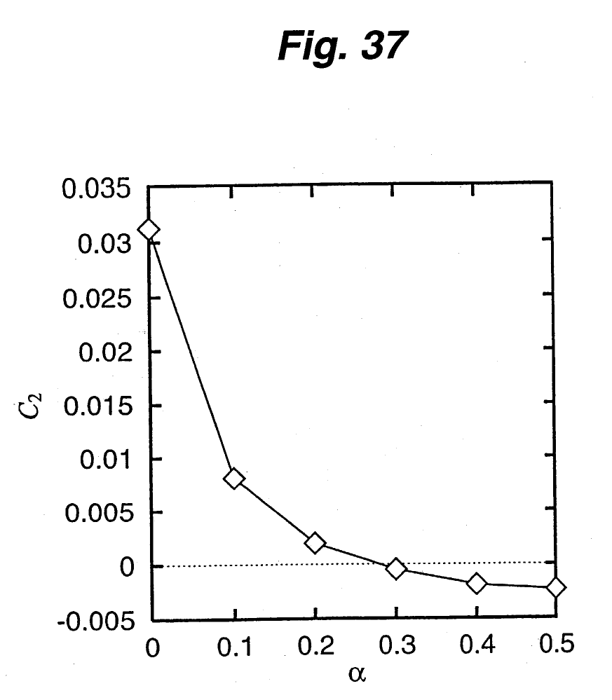

FIG. 32 and FIG. 30 respectively show the coefficients C₁ and C₂ in the case where Ω(r) under 0<r<10 is optimally approximated by Equation 120 when R=0 and α=0 in FIG. 29. FIG. 34 and FIG. 35 respectively show the coefficients C₁ and C₂ in the case where Ω(r) under 0<r<10 is optimally approximated by Equation 120 when N=10 and α=0 in FIG. 30. FIG. 37 and FIG. 37 respectively show the coefficients C₁ and C₂ in the case where Ω(r) under 0<r<10 is optimally approximated by Equation 120 when N=10 and R=0 in FIG. 31.

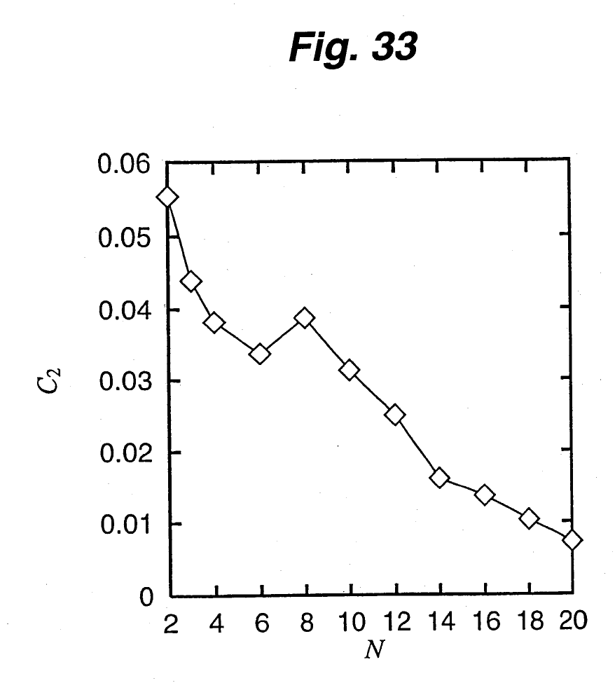

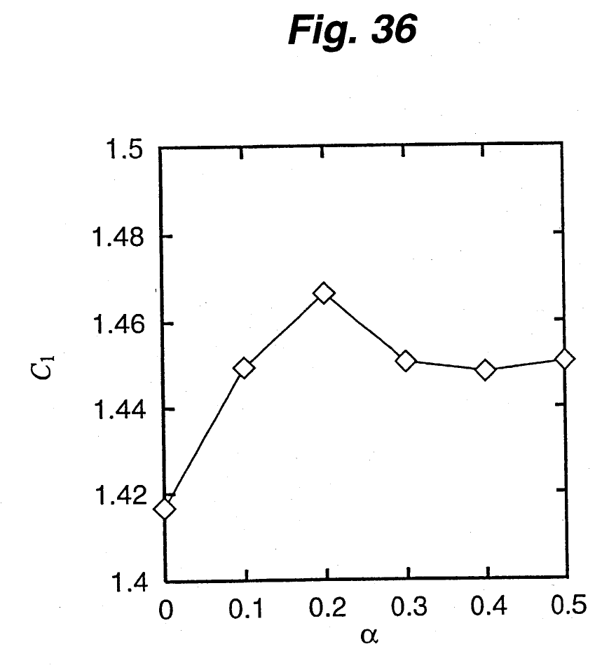

In the cases of FIGS. 29 and 30, the coefficient C₁ of O(r²) is modified well by N and R as shown in FIGS. 32 and 34. As appreciated from FIGS. 33 and 35, since C₂ is very small, Ω(r) is described well by quadratic functions. This demonstrates that these multiply-twisted helixes have three-dimensional properties, but they are controlled in number of sites in the region separated by the distance r from a certain site by modulation of its coefficients. Therefore, physical phenomena appearing on the structures are controllable. What can be said from those results is that, even in the order of r˜10, evaluation of the average number of nearest-neighbor sites is directly valid and modulability in the multiply-twisted helix extends even globally. In case of FIG. 31, as apparent from FIGS. 36 and 37, there is almost no change in C₁ even with changes of α unlike the foregoing two examples. On the other hand, C₂ varies to a certain degree, and its sign is inverted. Therefore, modulability under changes of α of FIG. 31 results in changes of the coefficient of O(r⁴).

Next explained is a multiply-twisted helix according to the first embodiment of the invention, standing on the understandings of the multiply-twisted helix already explained. In the first embodiment, the interval N^{m} in the above-explained multiply-twisted helix is generalized, and an arbitrary one-dimensional function g(m)=βm+γ is assumed as the exponent of N. It is intended to demonstrate that new design freedom can be introduced especially under γ≠0, and the spatial bondability in the system is analyzed by cellular automaton dynamics.

Assuming a one-dimensional lattice, numbers are assigned as p= . . . , −1, 0, 1, . . . . Bondability between the elements defines a multiply-twisted helix. For the purpose of defining nearest neighbor elements,

$${J}_{p , q} = {J}_{q , p} = \{ \begin{matrix}1 & when & \vert p - q \vert = 1 \\ s & when & \vert p - q \vert = {N}^{g ( 1 )} \\ {s}^{2} & when & mod ( p , {N}^{g ( 1 )} ) = 0 and q = p + {N}^{g ( 2 )} + f ( {N}^{g ( 1 )} ) \\ {s}^{3} & when & mod ( p , {N}^{g ( 2 )} ) = 1 and q = p + {N}^{g ( 3 )} + f ( {N}^{g ( 2 )} ) \\ {s}^{4} & when & mod ( p , {N}^{g ( 3 )} ) = 2 and q = p + {N}^{g ( 4 )} + f ( {N}^{g ( 3 )} ) \\ & ⋮ & \\ 0 & otherwise & \end{matrix} \qquad ( 94 )$$

is introduced, and s=1 is used hereunder. Assume that the p-th element and the q-th element are the nearest-neighbor elements when J_{p,q}=1. f(x) is an arbitrary function that takes an integer value. g(x) is an arbitrary linear function, and let it be described as

g(x)=βx+γ (95)

If

N^{β}=L (96)

then a structure corresponding to the above-explained multiply-twisted helix but having the number of turns L is given. On the other hand, the structure under γ≠0 is one that is first proposed here and different from the above-explained multiply-twisted helix. Hereunder, f(x)=0 is used, and its spatial bondability is analyzed.

For analyzing the spatial bondability, a certain sense of spacing is introduced between sites that are not nearest neighbor sites, and the number of sites existing at the distance from a certain site is calculated. For this purpose, a simple cellular automaton (CA) is introduced. A variable of σₙ=1 or 0 is introduced to the n-th site. Let this variable be capable of varying with time t=0, 1, . . . , and let it written as σₙ(t).

As the initial condition

$${σ}_{n} ( 0 ) = \{ \begin{matrix}1 & when & n = p \\ 0 & when & n \neq p\end{matrix} \qquad ( 97 )$$

is used. As the CA dynamics

$${σ}_{n} ( t + 1 ) = Θ ( {\sum }_{m} {J}_{n , m} {σ}_{m} ( t ) ) \qquad ( 98 )$$

is used, where

$$Θ ( x ) = \{ \begin{matrix}1 & when & x > 0 \\ 0 & when & x \leq 0\end{matrix} \qquad ( 99 )$$

Through this time development, the time t when the q-th site first becomes σ_{q}(t)=1 is used to define the distance Δ_{p, q} between the p-th site and the q-th site.

A physical interpretation is given beforehand to the distance Δ_{p, q}. There are a plurality of paths connecting the p-th site and the q-th site via the nearest-neighbor sites, and the shortest one is the aforementioned distance. In a continuous three-dimensional space (x, y, z), it corresponds to a case where |x|+|y|+|z| is employed as the distance from the origin. In CA mentioned above, propagation to the nearest-neighbor site occurs during the time width 1, and the time required for σₚ(0)=1 having localized in the p-th site to reach the q-th site was measured to be used as the distance. Of course, the distance introduced here satisfies the axioms

Δ_{p,q}≧0 (100)

Δ_{p,q}=Δ_{q,p} (101)

Δ_{p,γ}≦Δ_{p,q}+Δ_{q,γ} (102)

By execution of this CA simulation, arbitrary (p, q) distance can be determined.

The quantity remarked in this first embodiment is the total number ω(r; pⱼ) of sites q at the distance Δ_{pj, q}=r from an arbitrary pⱼ-th site. What is calculated below is the quantity

$$Ω ( r ) = \frac{1}{{M}_{s}} {\sum }_{j = 1}^{{M}_{s}} ω ( r ; {p}_{j} ) \qquad ( 103 )$$

to be obtained by using a multiply-twisted structure made up of M=10001 sites and averaging Mₛ=1000 samples selected as pⱼ sites from them. It will be readily understood that this quantity becomes

Ω(r)=Const.+4r² (104)

in case of a three-dimensional cubic lattice.

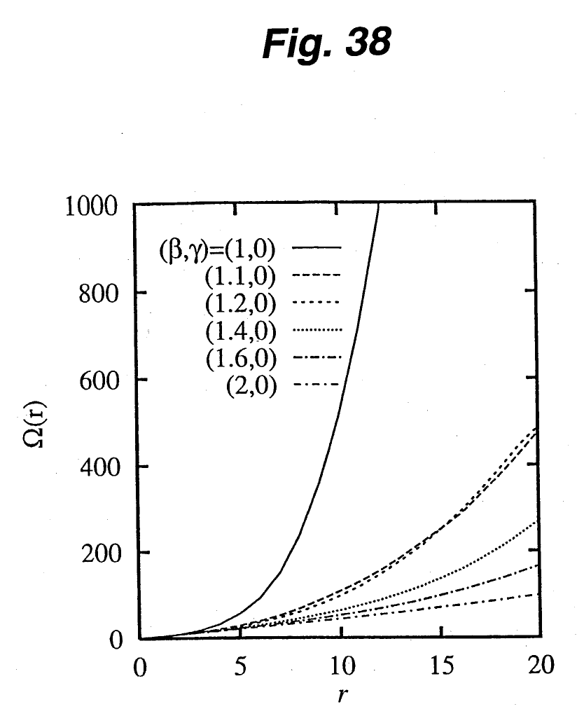

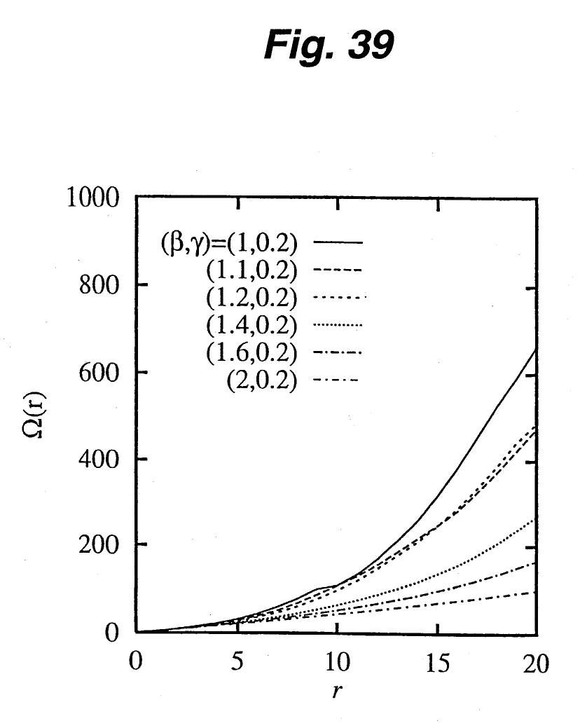

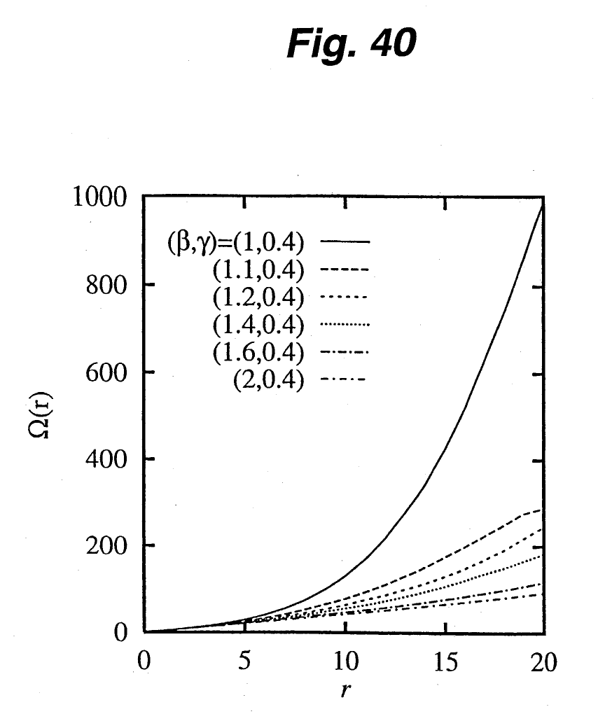

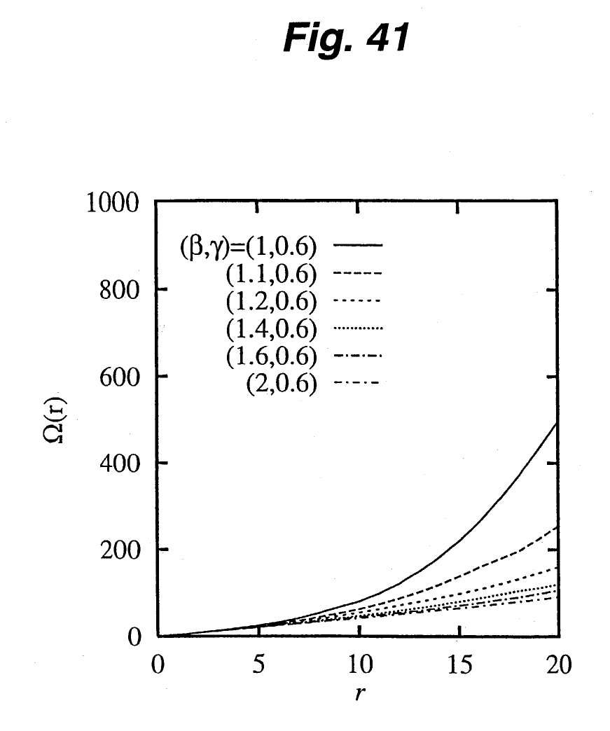

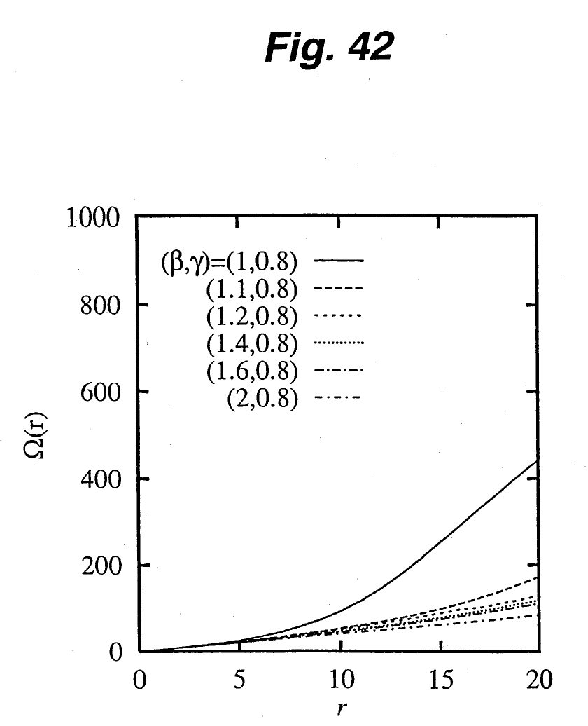

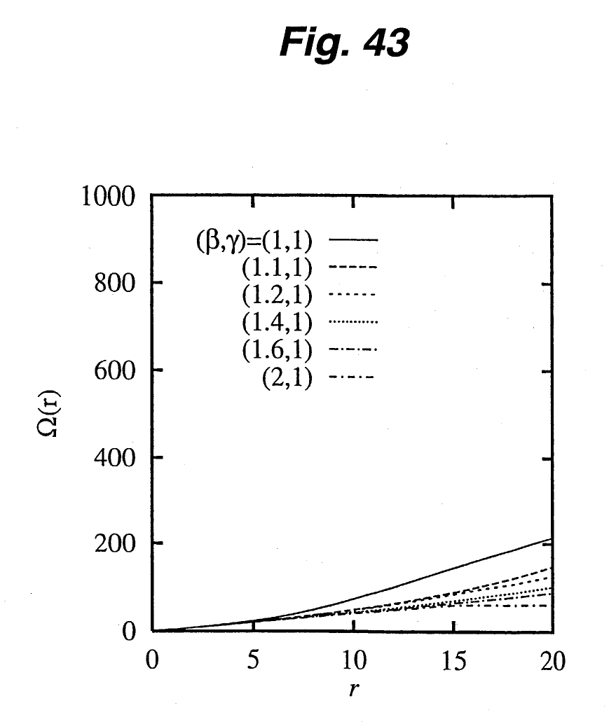

Ω(r) in the extended multiply-twisted helix fixed as N=10 will be calculated below. In FIG. 38, Ω(r) in case of γ=0 and was plotted for various values of β. In this case, as already discussed, the same change as that by changes of N in the above-explained multiply-twisted helix is induced by changes of β. It is appreciated that Ω(r) is approximated well by quadratic functions in the region where r is small, and its coefficient is modified by β. Further, Ω(r) was plotted for various values of β in FIG. 39 for the case of γ=0.2, in FIG. 40 for the case of γ=0.4, in FIG. 41 for the case of γ=0.6, in FIG. 42 for the case of γ=0.8 and in FIG. 43 for the case of γ=1. Changes of Ω(r) responsive to the increase of β are similar to those of FIG. 38. However, Ω(r) decreases as γ increases, and certain changes are observed also in behaviors near r˜0. Therefore, spatial bondability shown by Ω(r) has been confirmed to be controllable by adjusting γ to a predetermined value together with β.

Next made is an analysis about influences of the new design freedom introduced by γ≠0 to physical phenomena appearing on the multiply-twisted helix. More specifically, electron structures of the Mott insulator in the extended multiply-twisted helix are analyzed to demonstrate that the density of states can be modified and the Hubbard gap can be controlled.

A half-filled electron system on the extended multiply-twisted helix is taken for consideration.

Regarding the electron system on the extended multiply-twisted helix, a single-band Hubbard Hamiltonian Ĥ is defined as follows.

$$\hat{H} = t {\sum }_{i , j , σ} {J}_{i , j} {\hat{c}}_{i , σ}^{†} {\hat{c}}_{j , σ} + U {\sum }_{j} {\hat{n}}_{j , ↑} {\hat{n}}_{j , ↓} \qquad ( 105 )$$

Letting electrons be movable only among neighboring sites, t=1 is used hereunder.

Here is defined a spin σ electron density operator of the j-th site, namely, \hat{n}_{j,σ}=ĉ_{j,σ}^{†}Ĉ_{j,σ}, and its sum \hat{n}ⱼ=Σ_{σ}\hat{n}_{j,σ}.

For the purpose of defining a temperature Green's function, here is introduced a grand canonical Hamiltonian \hat{K}=Ĥ−μ\hat{N} where \hat{N}=Σⱼ\hat{n}ⱼ. In the half filled remarked here, chemical potential is μ=U/2. The half-filled grand canonical Hamiltonian can be expressed as

$$\hat{K} = t {\sum }_{i , j , σ} {λ}_{j , i} {\hat{t}}_{j , i , σ} + U / 2 {\sum }_{i} ( {\hat{u}}_{i} - 1 ) \qquad ( 106 )$$

Operators \hat{t}_{j,i,σ}, ĵ_{j,i,σ}, ûᵢ and \hat{d}_{i,σ} are defined beforehand as

\hat{t}_{j,i,σ}=ĉ_{j,σ}^{†}ĉ_{i,σ}+ĉ_{i,σ}^{†}ĉ_{j,σ} (107)

ĵ_{j,i,σ}=ĉ_{j,σ}^{†}ĉ_{i,σ}−ĉ_{i,σ}^{†}ĉ_{j,σ} (108)

ûᵢ=ĉ_{i,↑}^{†}ĉ_{i,↑}ĉ_{i,↓}^{†}ĉ_{i,↓}+ĉ_{i,↑}ĉ_{i,↑}^{†}ĉ_{i,↓}ĉ_{i,↓}^{†} (109)

\hat{d}_{i,σ}=ĉ_{i,σ}^{†}ĉ_{i,σ}−ĉ_{i,σ}ĉ_{i,σ}^{†} (110)

If the temperature Green function is defined for operators Â and \hat{B} given, taking τ as imaginary time, it is as follows.

$$⟨ \hat{A} ; \hat{B} ⟩ = - {\int }_{0}^{β} ⅆ τ ⟨ {T}_{τ} \hat{A} ( τ ) \hat{B} ⟩ {ⅇ}^{{ⅈω}_{n} τ} \qquad ( 111 )$$

The on-site Green function

G_{j,σ}(iωₙ)= [symbol] ĉ_{j,σ};ĉ_{j,σ}^{†} [symbol] (112)

is especially important because, when analytic continuation is conducted as iωₙ→ω+iδ for a small δ,

$${D}_{j} ( ω ) = - {\sum }_{σ = ↑ , ↓} Im {G}_{j , σ} ( ω + i δ ) \qquad ( 113 )$$

becomes the local density of states of the site j, and

$$D ( ω ) = - {\sum }_{j , σ} Im {G}_{j , σ} ( ω + i δ ) \qquad ( 114 )$$

becomes the density of states of the system. For later numerical calculation of densities of states, δ=0.0001 will be used. Further, the total number of sites is assumed to be n=10001 to impose a periodical boundary condition.

Imaginary time development of the system is obtained by the Heisenberg equation

$$\frac{ⅆ}{ⅆ τ} \hat{A} ( τ ) = [ \hat{K} , \hat{A} ] \qquad ( 115 )$$

As the equation of motion of the on-site Green function,

$$i {ω}_{n} ⟨ {\hat{c}}_{j , σ} ; {\hat{c}}_{j , σ}^{†} ⟩ = 1 + t {\sum }_{p , j} {λ}_{p , j} ⟨ {\hat{c}}_{p , σ} ; {\hat{c}}_{j , σ}^{†} ⟩ + \frac{U}{2} ⟨ {\hat{d}}_{j , - σ} {\hat{c}}_{j , σ} ; {\hat{c}}_{j , σ}^{†} ⟩ \qquad ( 116 )$$

is obtained. Then, the approximation shown below is introduced, following Gros ((31) C. Gros, Phys. Rev. B50, 7295(1994)). If the site p is the nearest-neighbor site of the site j, the resolution

[symbol]

ĉ_{p,σ};ĉ_{j,σ}^{†} [symbol] →t [symbol] ĉ_{p,σ};ĉ_{p,σ}^{†} [symbol] [symbol] ĉ_{j,σ};ĉ_{j,σ}^{†} [symbol] (117)

is introduced as the approximation. This is said to be exact in case of infinite-dimensional Bethe lattices, but in this case, it is only within approximation. Under the approximation, the following equation is obtained.

$$\begin{matrix}( ⅈ {ω}_{n} - {t}^{2} {Γ}_{j , σ} ) {G}_{j , σ} = 1 + \frac{U}{2} ⟨ {\hat{d}}_{j , - σ} {\hat{c}}_{j , σ} ; {\hat{c}}_{j , σ}^{†} ⟩ \\ where & ( 118 ) \\ {Γ}_{j , σ} = {\sum }_{p} {λ}_{p , j} {G}_{p , σ} & ( 119 )\end{matrix}$$

was introduced. To solve the equation obtained, [symbol] \hat{d}_{j,-σ}ĉ_{j,σ};ĉ_{j,σ}^{†} [symbol] must be analyzed. In case of half-filled models, this equation of motion is

$$\begin{matrix}{ⅈω}_{n} ⟨ {\hat{d}}_{j , - σ} {\hat{c}}_{j , σ} ; {\hat{c}}_{j , σ}^{†} ⟩ = \frac{U}{2} {G}_{j , σ} - 2 t {\sum }_{p} {λ}_{p , j} ⟨ {\hat{j}}_{p , j , - σ} {\hat{c}}_{j , σ} ; {\hat{c}}_{j , σ}^{†} ⟩ + \\ t {\sum }_{p } {λ}_{p , j} ⟨ {\hat{d}}_{j , - σ} {\hat{c}}_{p , σ} ; {\hat{c}}_{j , σ}^{†} ⟩\end{matrix} \qquad ( 120 )$$

Here again, with reference to the Gros logic, approximation is introduced. It is the following translation.

[symbol]

ĵ_{p,j,-σ}ĉ_{j,σ};ĉ_{j,σ}^{†} [symbol] →−tG_{p,-σ} [symbol] \hat{d}_{j,-σ}ĉ_{j,σ};ĉ_{j,σ}^{†} [symbol] (121)

[symbol]

\hat{d}_{j,-σ}ĉ_{p,σ};ĉ_{j,σ}^{†} [symbol] →tG_{p,σ} [symbol] \hat{d}_{j,-σ}ĉ_{j,σ};ĉ_{j,σ}^{†} [symbol] (122)

By executing this translation, the following closed equation is obtained.

$$( ⅈ {ω}_{n} - {t}^{2} {Γ}_{j , σ} ) {G}_{j , σ} = 1 + \frac{{( U / 2 )}^{2}}{{ⅈω}_{n} - {t}^{2} {Γ}_{j , σ} - 2 {t}^{2} {Γ}_{j , - σ}} {G}_{j , σ} \qquad ( 123 )$$

Assume here that there is no dependency on spin. That is, assuming

G_{j,↑}=G_{j,↓} (124)

the following calculation is executed.

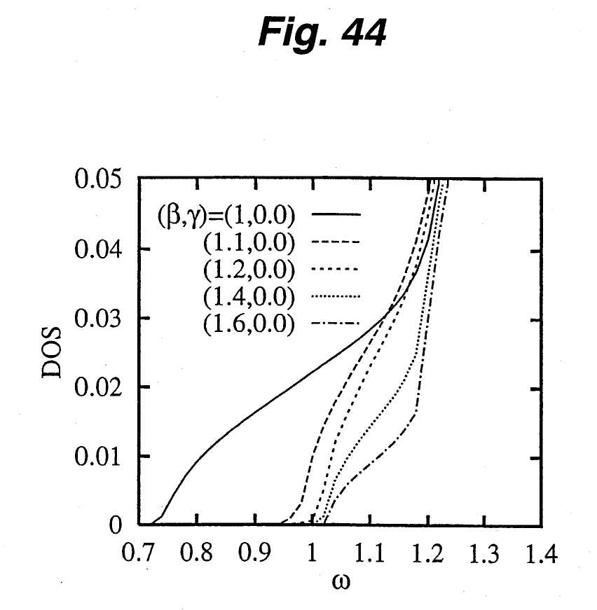

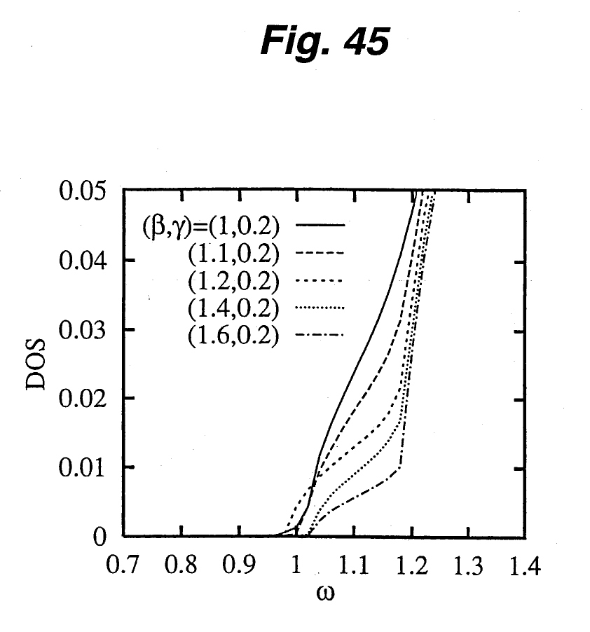

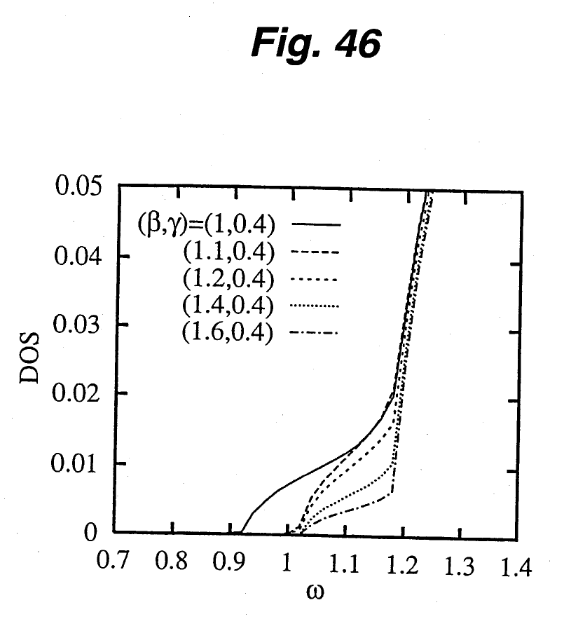

For discussing controllability by β and γ, the electron interaction and the turn pitch are fixed at U=10 and N=10, respectively. Then, the system behaves as a Mott insulator. Densities of states (DOS) calculated are shown in FIGS. 44 through 46. Calculation was carried out by changing β as β=1, 1.1, 1.2, 1.4 and 1.6 while setting γ as γ=0 in FIG. 44, γ=0.2 in FIG. 45 and γ=0.4 in FIG. 46. First made is a review on FIG. 44. The value twice the energy (abscissa ω) where the density of states isappears is the width of the Hubbard gap. It is appreciated that the Hubbard gap increases with β. This modulation is the same as the multiply-twisted helix explained above. On the other hand, in case of γ=0.2 of FIG. 45, an effect by extension appears. The Hubbard gap width, itself, does not change so much, but the dependency of the density of states on energy largely changes, and it is presumed that the excitation spectrum of the system is largely affected. The density of states shown in FIG. 46 for γ=0.4 is apparently different from those of FIGS. 44 and 45. This is the effect of γ>0. Therefore, in extended multiply-twisted helixes under γ>0, structurally correlated electron systems have been confirmed to be controllable.

Heretofore, one embodiment of the invention has been explained concretely. However, the invention is not limited to that embodiment, but contemplates various modifications or changes within the technical concept of the invention as well.

As described above, according to the invention, in a multiply-twisted helix in which spiral structures bond to each other at least at one position at least between layers, and the number of turn of the spiral structure of the lowest layer is N, since the interval of m-th degree bonds between layers is determined by the power function N^{g(m)} of N having an arbitrary linear function g(m)=βm+γ (where β and γ are constant values and γ≠0) of m as its exponent, the spatial bondability in the multiply-twisted helix, i.e. the global bondability between elements, can be controlled by changing the exponent. Thus the physical property that appears, such as electron correlation in electron systems, can be controlled. This makes it possible to obtain a new high-functional material that is complementary with a fractal-structured material and exhibits a new physical property.

1. A multiply-twisted helix having a hierarchical structure in which a linear structure as an element of a particular spiral structure is made of a thinner spiral structure, said spiral structures being bonded in at least one site at least between two layers, and the number of turns of said spiral structure of the lowest layer being N, characterized in:
the interval of m-th degree bonds between layers being determined by the power function N^{g(m)} of N having an arbitrary linear function g(m)=βm+γ (where β and γ are constant values and γ≠0) of m as its exponent.

2. The multiply-twisted helix according to claim 1 wherein bondability between elements of said helix is controlled by adjusting β or γ to a predetermined value.

3. The multiply-twisted helix according to claim 1 wherein electron correlation in an electron system on said helix is controlled by adjusting β or γ to a predetermined value.

4. A functional material at least partly made up of a multiply-twisted helix including having a hierarchical structure in which a linear structure as an element of a particular spiral structure is made of a thinner spiral structure, said spiral structures being bonded in at least one site at least between two layers, and the number of turns of said spiral structure of the lowest layer being N, characterized in:
the interval of bonds between m-th degree layers in said multiply-twisted helix being determined by the power function N^{g(m)} of N having an arbitrary linear function g(m)=βm+γ (where β and γ are constant values and γ≠0) of m as its exponent.

5. The functional material according to claim 4 wherein bondability between elements of said helix is controlled by adjusting β or γ to a predetermined value.

6. The functional material according to claim 4 wherein electron correlation in an electron system on said helix is controlled by adjusting β or γ to a predetermined value.
